(19) United States
(12) Patent Application Publication
(10) Pub. No.: US 2011/0246390 A1
(43) Pub. Date: Oct. 6, 2011

(54) SYSTEM AND METHOD FOR CONSTRUCTING INVESTMENT INSTRUMENTS, PORTFOLIOS , AND BENCHMARK INDEXES WITH ACTIVE LEVERAGED WRITTEN CALL OR PUT OPTIONS OVERLAY

(75) Inventor: Zhaoji George Yang, Canton, MI (US)

(73) Assignee: Zhaoji George Yang, Canton, MI (US)

(21) Appl. No.: 13/078,974

(22) Filed: Apr. 3, 2011

Related U.S. Application Data
(60) Provisional application No. 61/321,135, filed on Apr. 6, 2010.

(51) Int. Cl. G06Q 40/00

(52) U.S. Cl. 705/36 R

(57) ABSTRACT

An electronic pricing and trading system and method can be used for providing financial investment instrument or performance benchmark through an investment portfolio. The investment portfolio can have a long exposure to one or more underlying equities or an equity index. A technical rule can be used to determine a pricing trend associated with the underlying equities periodically. The technical rule can be electronically calculated based on prices of the one or more underlying equities or equity index investment, and a determined pricing trend is one of an up trend and a down trend. An option overlay component can be associated with the investment portfolio based on a determined pricing trend. For an up trend, the option overlay component contains written or shorting put options associated with the underlying equities or equity index. And, for a down trend, the option overlay component contains written or shorting call options associated with the underlying equities or equity index.

### CLAIM OF PRIORITY

This application claims priority to U.S. Provisional Application No. 61/321,135 entitled “Methods of Constructing Equity Index Based Investment Instruments and Portfolios with Variable Allocations to the Underlying Equities and Active Leveraged Written Call or Put Options Overlay” filed Apr. 6, 2010 and the entirety of the above-noted application is incorporated here in by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

This invention relates generally to using electronic pricing and trading platform for constructing financial investment instruments, portfolios or benchmark indexes, and more particular to an electronic pricing and trading platform for constructing equity index based investment instruments, portfolios or benchmark indexes with active leveraged written call or put options overlay.

### BACKGROUND

Stock market predictability, portfolio allocation and derivative pricing, are three prominent topics in modern finance. Besides ample academic and empirical research, there are great practical interests to develop and implement investment strategies and products reflecting these theoretical underpinnings.

As simple passive portfolio strategies, “Buy-Write” (covered call option writing) and “Put-Write” (cash collateralized shorting of put option) had been applied to broad stock market indexes, notably, S&P 500 Index (SPX) as a first. In 2002, Chicago Board of Option Exchange (CBOE) introduced S&P 500 Monthly Buy-Write Index (BXM) which can be used as a performance benchmark for related 1940 Act mutual funds, exchange-traded-funds (ETF) and other investment products. BXM was examined by Whaley (2002, 2010) and Feldman and Roy (2005) regarding its performance characteristics, invest-ability and the sources driving the performance. Investment products like PowerShares S&P 500 Buy-Write ETF (Ticker: PBP) and iPath CBOE S&P 500 Buy-Write Index ETN (Ticker: BWV) seek to replicate the performance of BXM on a net-of-fee basis. The CBOE S&P 500 Monthly Put-Write Index (PUT) was launched in 2007, followed by Ungar and Moran (2009)'s detailed analysis. It has been observed over at least the last two decades that S&P 500 Index short term 30-day implied volatilities from index options were larger than subsequent 30-day realized volatilities on the index itself. Through mechanical index option writing, standard Buy-Write and Put-Write strategies achieved better returns and reduced risks on average than the S&P 500 Index.

However, it should also be emphasized that Buy-Write and Put-Write strategies under-performed the underlying equity index in strong rising markets such as the 1990's, and that they could not avoid heavy losses during precipitous market declines, most recently in the 2008-2009 market crisis. The Buy-Write and Put-Write strategies use 100% fixed allocations in their simple portfolio to fully cover or collateralize written index option positions. In other words, regardless any fundamental or technical market predictions, they always target at a constant portfolio beta (around one half for BXM and PUT in nominal term) to cause under-exposure in a bull market, and over-exposure (compared to that of risk free bonds) in a bear market. To alleviate the underperformance of Buy-Write strategy in a rising market, written out-of-money (OTM) call options (over-writing) can be used to reduce the chances of exercise in the money, but usually with the trade-off of collecting less call premium. The CBOE S&P 500 2% OTM Buy-Write Index (BXY) is an index of passive over-writing that exhibited better risk-adjusted return than BXM.

Hill et al (2006) considered a dynamic strike modification to the over-writing Buy-Write strategy based on on-going volatility environment. A jump in the implied volatilities of index options generally accompanies a market drop, and vice versa. Targeting at a fixed probability of index options expiring in-the-money, larger implied volatility raises the out-of-money strike prices of the written calls and reduces the call premium collected. Thus compared to the fixed call over-writing strategies, the market timing of dynamic strike can generally improve an over-writing strategy's return when the market's rising or falling short term trend reverses by the option expiration day of the coming month.

Recent practice as variations of Buy-Write index strategy also introduced market timing, for example, to adjust the strike price or money-ness of the written call options using technical analysis rules of simple moving average (SMA) cross. RBOI (Rules-Based-Option-Index) is a customary S&P 500 based Buy-Write Index with available on Bloomberg system. By predicting market trend from 200-day SMA cross of S&P 500 index, a customary Buy-Write index can use at-the-money or in-the-money call option writing in a bearish regime and an out-the-money call option writing in a bullish regime to seek performance improvement over standard Buy-Write strategies.

Dynamic asset allocation can be used for a simple portfolio of stock index and risk free asset to out-perform a passive optimal portfolio derived from modern portfolio theory. In particular, Zhu and Zhou (2009) focused on technical analysis rules of moving average as the market timing system for dynamic asset allocation in stock (S&P 500 index) and risk-less bond. They found that, with a simple moving average cross signal, active two-state constant adjustment to the fixed optimal portfolio weights can improve portfolio performance substantially.

### BRIEF DESCRIPTION OF THE FIGURES

FIG. 1 is an exemplary illustration of a flow chart for constructing investment instruments, portfolios or benchmark indexes through reference portfolio with active leveraged written call or put options overlay in accordance to an embodiment of the invention.

FIG. 2 is an exemplary illustration of a flow chart for managing an Active Leveraged Options Overlay Portfolio (ALOOP) as a reference portfolio in accordance to an embodiment of the invention.

FIG. 3 is an exemplary illustration of an electronic pricing and trading system in accordance to an embodiment of the invention.

FIG. 4 is an exemplary illustration of a 21-year history (1990-2010) for the slope of logarithmic volatility skew on S&P 500 Index, estimated by the monthly logarithmic change of implied monthly volatilities of SPX options divided by monthly logarithmic return of S&P 500 Index.

FIG. 5 is an exemplary illustration of the Histogram for the slope of logarithmic volatility skew quantities of FIG. 4, showing mean of the computed values at −3.45.

FIG. 6 is an exemplary illustration of a 21-year history (1990-2010) for the product of implied monthly volatility and slope of logarithmic volatility skew, for S&P 500 Index.

### SUMMARY

In accordance with one embodiment of the present invention, an electronic pricing and trading system and method can be used for providing financial investment instruments or benchmark indexes through a reference portfolio. The reference portfolio can have a portion of long exposure to one or more underlying equities, or equity indexes. A technical rule or multiple technical rules can be used to determine a pricing trend associated with the one or more underlying equities or equity indexes periodically. Technical rule(s) can be electronically calculated based on prices of the one or more underlying equities or equity indexes, and their options price implied quantities, and the determined pricing trend is one of an up trend and a down trend. An option overlay component can be associated with the reference portfolio based on a determined pricing trend. For an up trend, the option overlay component is a first option overlay component that contains written or shorting put options associated with the underlying equities or equity indexes. And, for a down trend, the option overlay component is a second option overlay component that contains written or shorting call options associated with the underlying equities or equity indexes.

### DETAILED DESCRIPTION

Even with the complexities of constantly changing financial markets, it is possible to use an electronic pricing and trading platform to implement a time tested investment scheme that addresses stock market predictability, portfolio allocation and derivative pricing, taking advantage of their interactions, and yet appealing to investors with feasibility, transparency and simplicity.

In accordance with one embodiment, an electronic pricing and trading platform can be used to construct a class of financial investment instruments, which can be provided as portfolios of long exposure to underlying equities, such as a basket of stocks representing an equity market index, or index futures contracts, and long exposure to risk free bonds, such as short-term government debt or money market funds, and active option overlays.

In accordance with one embodiment, an electronic pricing and trading platform can be used to construct a class of investment benchmark indexes, which can be provided through referencing investment portfolios that have long exposure to underlying equities, such as a basket of stocks representing an equity market index, or index futures contracts, and long exposure to risk free bonds, such as short-term government debt or money market funds, and active option overlays. These actual or hypothetical investment portfolios are exemplary reference portfolios.

The active option overlay components of the reference portfolio can be implemented as written (shorting) equities or equity index puts or calls options and allows switching between the two types of options according to a first technical rule that is based on the past and current prices of the underlying equities and options implied quantities such as volatilities. The option overlay can be written puts options when the first technical rule indicates bullishness, an upward trend that expects the underlying equity index to rise, and can switch to written calls options when the first technical rule indicates bearishness, or a downward trend that expects the underlying equity index to decline.

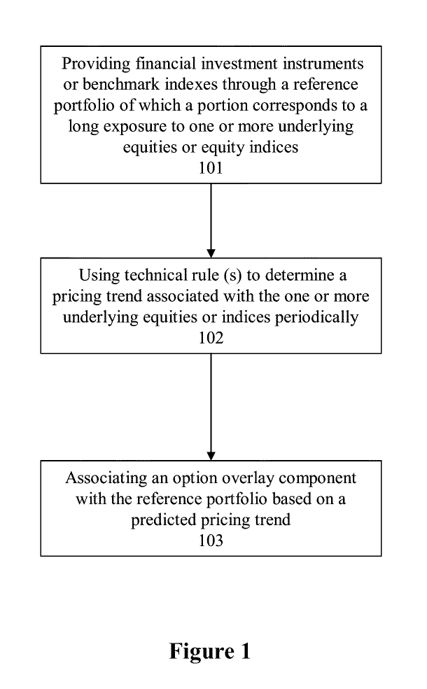

FIG. 1 is an exemplary illustration of a flow chart for constructing equity index based investment instruments, portfolios or benchmark indexes through reference portfolio with active leveraged written call or put option overlay in accordance to an embodiment of the invention.

As shown in FIG. 1, using an electronic pricing and trading platform, a class of financial investment instruments or benchmark indexes can be provided through a reference portfolio with a portion of long exposure to one or more underlying equities or equity indexes at step 101. A technical rule or multiple technical rules can be used to determine a pricing trend associated with the one or more underlying equities or equity indexes periodically at step 102. The technical rule can be electronically calculated using the electronic pricing and trading platform. The technical rule are calculated based on prices of the one or more underlying equities or equity indexes, and equity or index option implied quantities, and the determined pricing trend is one of an up trend and a down trend. An option overlay component can be associated with the reference portfolio using the electronic pricing and trading platform based on a determined pricing trend at step 103. On one hand, for or an up trend, the option overlay component is a first option overlay component that contains written or shorting put options associated with the underlying equities or equity index. On the other hand, for a down trend, the option overlay component is a second option overlay component that contains written or shorting call options associated with the underlying equities or equity index.

In accordance with one embodiment, the electronic pricing and trading platform can combine historically observed favorable characteristics from Buy-Write and Collateralized Put-Write portfolio strategies with active technical rules or schemes, i.e., an Active Leveraged Option-Overlay Portfolio (abbreviated as ALOOP) strategy or investment methodology. As a reference portfolio, the ALOOP portfolio can be associated with different binary (either bullish or bearish) technical rules based on market price and option price implied quantities, different leverage parameters to control portfolio allocations, different types of investment components in the portfolio, different types of trading transactions for the portfolio re-allocation, and different time intervals/frequency or date specifications for portfolio rebalance, monitoring and trading according to the technical rules.

In accordance with one embodiment, the electronic pricing and trading platform can use different parameters for controlling the reference portfolio's total portfolio leverage, such as the portfolio's excessive long or short exposure to underlying equities or index investment beyond the neutral exposure levels implied in the passive Collateralized Put-Write strategy or Buy-Write portfolio strategy, respectively.

In accordance with one embodiment, the electronic pricing and trading platform allows different portfolio components. One portfolio component includes a long exposure in underlying equities or index as a portion of the total portfolio market value. A long exposure in the underlying equities or equity index can be implemented as: a portfolio of stock investment positions that constitutes the index, or an Exchange Traded Fund (ETF) or Exchange Traded Note (ETN) benchmarked to the underlying equity index, open-ended or closed-ended index mutual funds, or the index based futures or equity swaps derivative contracts, etc., or any combinations of such. Another portfolio component includes a long exposure in risk free assets (or bonds) as the rest portion of the total portfolio market value. The risk free assets can be Cash or Cash equivalent instruments such as Short Term US Treasuries securities, Money Market Funds, Discounted Notes from Government Agencies, or Certificates of Deposits from a bank or a financial institution, etc., that satisfies the requirement of Clearing House for an Option Exchange as performance bond collaterals, or their combinations of such. The third portfolio component includes written Call Index Options when the technical rule dictates bearish-ness, or, written Put Index Options when the technical rule dictates bullishness wherein the options' notational exercisable value equals or below to the total portfolio market value. The put or call options can be index options listed on an Option Exchange such as CBOE, or options on an ETF for the underlying index, or options on the equity index futures, or any equivalent Over-the-Counter derivative contracts, etc., or their combinations of such.

In accordance with one embodiment, the electronic pricing and trading platform allows different market transactions specific to an ALOOP portfolio. When the technical rule triggers a change of expectation from bullishness to bearishness (or vice versa), the electronic pricing and trading platform supporting the ALOOP portfolio allows to close the written put options position and initiate the written call options (or vice versa). When the technical rule triggers a change of expectation from bullishness to bearishness (or vice versa), the electronic pricing and trading platform supporting the ALOOP portfolio allows change the portfolio exposure allocations in underlying equity index and risk free bonds, or reduce the allocations to equity index exposure and increase the allocations to risk free bond exposure (or vice versa). During a trading session, after noon until close to the day's market close, prior to monthly index option expiration, the electronic pricing and trading platform supporting the ALOOP portfolio allows to roll over the written put or call options to contracts with following month expiration, and rebalance portfolio to target allocations for exposure in both equity index and risk free bonds.

In accordance with one embodiment, the electronic pricing and trading platform allows different categories of transaction frequencies (or time intervals as reciprocal of frequencies) and associated portfolio transaction date specifications. The first category includes portfolio rebalancing time interval, which defines the rebalance frequency as monthly, quarterly or weekly, and the date of portfolio rebalance which can be the day before option expiration or a day in the week before the option expiration. The second category includes the frequency of monitoring the first technical rule and the date of trading when the first technical rule is triggered for any portfolio transaction. Finally, the third category includes, within the rebalance time interval, the frequency and the date of monitoring the secondary technical rule(s) and date of trading when the secondary technical rule(s) is (are) triggered for any portfolio transaction.

In accordance with one embodiment, the electronic pricing and trading platform allows different technical rules. A first technical rule allows the detection of market trend in underlying equities or index: rising (bullish) or declining (bearish), based on current or historical prices of the underlying equities or equity index. The secondary technical rule allows the detection of reversal of market trend in the underlying equities or equity index, usually within the portfolio rebalance time interval, bullish-to-bearish or bearish-to-bullish, based on current or historical prices of the underlying equities or equity index, and current and historical equity or index option price implied quantities, such as expected volatilities, and their combinations in certain mathematical forms.

In accordance with one embodiment, with an automated electronic system and computer network, the first technical rule can be monitored periodically, such as daily at or close to market close, during the said rebalance time interval. When the first technical rule signals switch from bullishness to bearishness or vice versa, switching option overlay from written puts to written calls or vice versa, can be executed at the day of the switch, or another day afterwards, or at the said chosen date that ends the rebalance time interval.

In accordance with one embodiment, a secondary technical rule can be defined based on the first technical rule and the past and current underlying equities prices and option implied quantities, with the output as whether to reverse the bullish or bearish underlying equity trend projection from the first technical rule during the rebalance interval. Through an automated electronic system and computer network, the secondary technical rule can be monitored periodically—daily, weekly or at a fixed frequency during the rebalancing time interval. When the conditions of the secondary technical rule are satisfied to over-write the bullishness or bearishness conclusion of the first technical rule within the rebalance time interval, switching option overlay positions in the portfolio from written puts to written calls or vice versa, can be executed at the day of the switch, or another day afterwards but before the said chosen date that ends the rebalance time interval.

The proportion of the reference portfolio's exposure in underlying equity index and risk free bonds can be fixed when the first or secondary technical rule(s) do not trigger any change in the option components of the portfolio. When technical rule switches from bullishness to bearishness or vice versa, the amount of reduction or increase in portfolio's underlying equity index exposure can be variable, reflecting preferred levels of leverage for the portfolio. Either from the first technical rule or the secondary technical rule(s), the levels of portfolio leverage for a bullish and a bearish trend projection, over the underlying equities or index investment, can be different. The two levels of leverage can be chosen specifically to sum to around one hundred percent, which can lead to zero or minimum change in allocations of the underlying equities or equity index component of the portfolio when the first technical rule or secondary technical rule(s) trigger options position change.

A rebalancing time interval such as a monthly interval and a fixed date during the time interval are chosen to rebalance among the components of portfolio including underlying equities or equity index based investments, risk free assets and options, to their target proportions. At the chosen date, the option overlay components which are usually close to expire can be closed or settled; new option overlay components can be written with at least the duration of the said rebalance time interval to their expirations. The money-ness (usually at-the-money or out-of-money) of the written put or call options overlay can be chosen consistently at the time of portfolio rebalance, and at the time of options position switch due to the triggering of the first technical rule.

Due to exchange specified or regulatory initial and maintenance margin requirement on written option contracts, the level of leverage for the bullish situation from either the first technical rule or secondary technical rule(s) is capped to a level less than one hundred percent. The portfolio can choose the said level of leverage and the number of put option contracts at reduced level such that the initial and maintenance option margin are satisfied during the whole rebalance time interval.

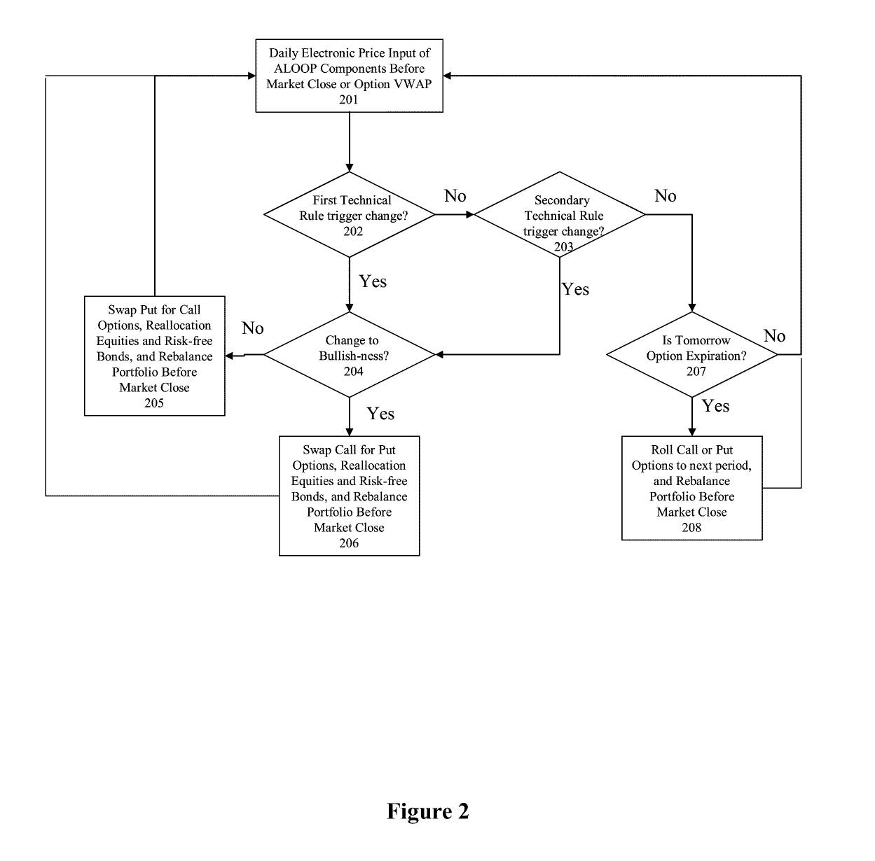

FIG. 2 is an exemplary illustration of a flow chart for managing a reference ALOOP portfolio in accordance to an embodiment of the invention.

As shown in FIG. 2, the system can receive or inquiry for daily electronic price input of ALOOP components before market close or during option Volume-Weighted-Average-Pricing (VWAP) period at step 201. A first technical rule can be evaluated daily to give a binary output as bullishness or bearishness at step 202, such as using daily close market prices of the underlying equity index to define a double cross technical rule. For example, Golden Cross or Black Cross (50-day simple moving average crosses above or below 200-day simple moving average) is used as an indicator that the underlying index is expected to rise (bullishness) or that the underlying index is expected to decline (bearishness). Without triggering change in trend of underlying equities or equity index from the first technical rule, a secondary technical rule can be evaluated at step 203. Checking of secondary technical rule is optional and can be based on equity index prices and index option implied quantities such as volatilities. For example, over a fixed monthly time period backward, a secondary technical rule can look at the change of at-the-money index option implied volatilities as a percentage of the index price rate of return. Other technical rules could also qualify as long as they are robust enough in a long term back test with the underlying index to have above 50% success rate in predicting a rising or falling trend, and have triggering frequency less frequent than monthly to avoid transaction cost burden due to excessive trading.

Continued to be shown in FIG. 2, at close to a trading session end, for example half an hour before session close, when the first technical rule is checked for triggering at Step 204. If the first technical rule checking indicates a change from bullishness to bearishness about the underlying equity index, the system allows trading transactions before market close to close by cash settlement or buying back the written index put options positions in the portfolio; this may involve additionally selling a portion of the holdings of risk free bonds, and writing front month expiration, at-the-money call options or slightly out-of-money call options; if tomorrow is the option expiration day of the month, option front month can be next month, and should be the same month otherwise; if the strike price of the call option to be written can be closest to just above the closed put options, or closest to the actual or anticipated close price of the underlying equity index; the number of contracts of written call options can have the underlying notional exercisable value equal or be as close as possible to the portfolio's market value which includes equity index exposure, risk free bond exposure, and the written call option premiums received; this can also involve rebalancing the portfolio by allocating to the said portions of long exposure in the equity index and in risk free bonds, usually at reduced percentage allocation in underlying equity index but increased percentage allocation in risk free bonds, at Step 205. Completed reverse portfolio transactions can be carried out at Step 206, if the first technical rule checking at Step 202 and 204 indicates a change from bearishness to bullishness about the underlying index. The bullishness or bearish conclusion from Step 204 after transactions of Step 205 and 206 is carried into next trading session at Step 201 to check for change. If the first technical rule checking at Step 202 indicates no change in trend prediction of the underlying index, an optional secondary technical rule(s) checking can be carried out at Step 203. The secondary technical rule can indicate a change in bullishness or bearishness of the underlying index back to Step 204, and subsequent portfolio transactions of Step 205 or 206 can be carried out as for the first technical rule. When the optional secondary technical rule checking indicates no change in predicted trend for the underlying index, option expiration schedule is checked as indicated in Step 207; if tomorrow or current trading session is a monthly option expiration day, the written call or put options positions within the portfolio can be closed by cash settlement or buying back; roll-over new call or put options positions can be established with a next month expiration date and strike price close to at the money or slightly out of money based on current or anticipated close price of the underlying equity index; portfolio components of long equity index exposure and risk free bonds can be rebalanced to their target proportional allocations as indicated in Step 208. When technical rule triggers any change just ahead of option expiration, the need of roll-over options and portfolio rebalance can be carried out in Step 205 and 206. After roll-over of options and portfolio rebalance of Step 208, the process flow is repeated for each trading session when the next option month begins at Step 201.

From a portfolio perspective, active option overlay portfolio (ALOOP) formulation with technical rule based active scheme can have two important aspects. First, using index put option writing rather than index call writing when expecting a rising trend in the underlying equity index. If the index rises in short term by next monthly index option expiration day, the current at-the-money index put option is expected to be less probable to expire in the money than the current at-the-money call option. At-the-money index put writing out-performs the at-the-money index call writing should the bullish prediction turn out to be true. Second, vary the portfolio's overall equity market exposure according to a technical rule, i.e., not only change the portfolio's written index option position on, put or call, strike price, but also modify portfolio weightings in underlying equity index and risk free bond accordingly. This essentially proposes dynamic asset allocation among portfolio components of underlying equity index, index options and risk free bond.

This formulation of dynamic asset allocation has two important aspects suitable for practical implementation. First, dynamic allocations switch between two sets of fixed weights for stock market index and risk free bond for a bullish or bearish index expectation respectively. This can be more robust than the continuous optimal dynamic allocations when there are significant uncertainties or errors in modeling of stock market index. The two sets of fixed weights can be specified through historical learning or optimization. Second, under reasonable long investment time horizon (e.g. ˜20 years), the optimal lag for the first technical rule based on moving average turns out much greater than 200 days for broad equity market index such as the S&P 500 Index (SPX). As a result, the moving average crosses that trigger option overlay trades and portfolio rebalance, are not too frequent to impact performance due to transaction costs and market friction.

### Electronic Pricing and Trading System/Platform

In accordance with one embodiment, an electronic pricing and trading platform based on computer platfoiin, communication network, and data and order flow, can be used to implement the financial investment instruments or benchmark indexes.

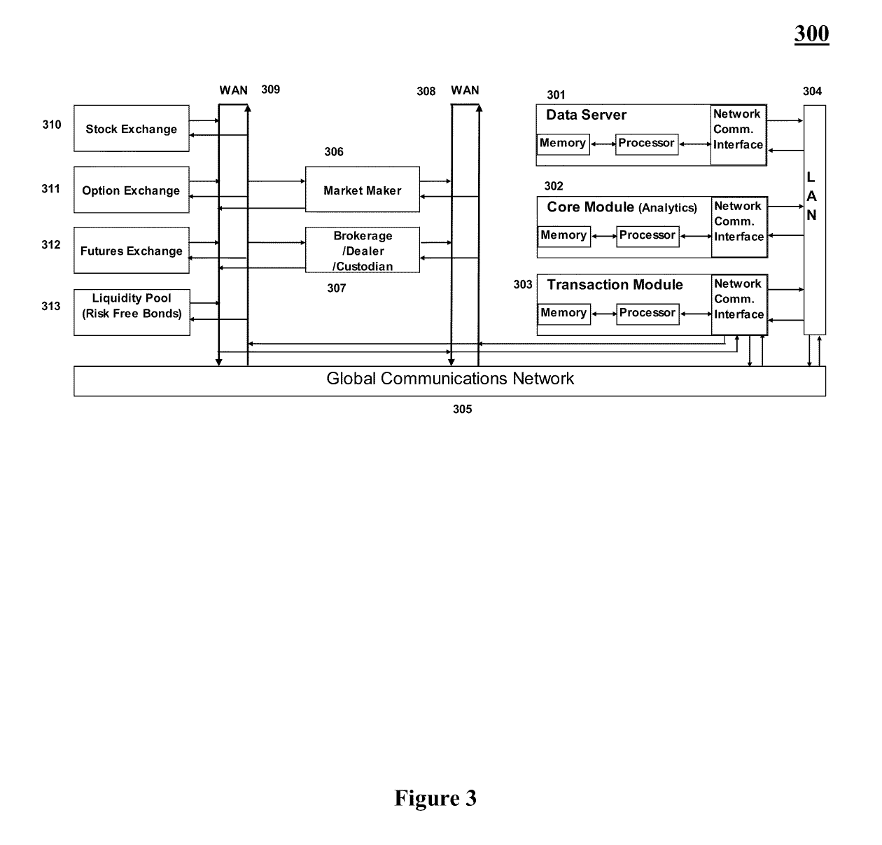

FIG. 3 is an exemplary illustration of an electronic pricing and trading system in accordance to an embodiment of the invention, where boxes represent physical or electronic entities, and lines with arrow end represent the transmission of price data, index data and transaction orders, namely, the price or order flow.

As shown in FIG. 3, the electronic pricing and trading system 300 includes two groups of entities. The first group is a major computer platform responsible for constructing financial investment instruments or benchmark indexes through a referenced portfolio. It can include a data server module 301, a core module 302 and a transaction module 303. Each module has electronic memory, single or multiple processors, and network communication interface. Each network communication interface enables the respective module to transmit information to or from a local area network (LAN) 304. LAN further allows connection with a Global Communications Network 305. Data server module 301 is responsible for accepting, storing and providing historical and current prices of relevant securities, instruments, market indexes and other benchmark information. The core module 302 handles investment related logic, analytics and decision-making tasks based on prices and other data input from LAN 304. The transaction module 303 allows generating buy or sell order(s) for a security or securities. The LAN 304 or Global Communications Network 305 further transmits the security price and order information to and from the second group of platform entities. In order to improve speed and reliability of data transmission and order execution, the network communication interface of the transaction module 303 can have direct connection with the second group of platform entities. The second group of platform entities can be of two types. One type is a financial exchange platform, including but not limited to stock exchange(s) 310, option exchange(s) 311, futures exchanges 312, and liquidity pool 313 such as the price quoting and trading platform for providers or buyers of risk free bonds. Another type is financial intermediaries, including but not limited to market maker(s) 306 and brokerage, dealers or custodians 307. Exchange platform entities can connect to a Wide Area Network (WAN) 309 which further has price and order flow exchange with Global Communications Network 305 or directly with network communication interface of transaction module 303. The platform of financial intermediaries can connect to a Wide Area Network (WAN) 308 which further has price and order flow exchange with Global Communications Network 305 or directly with network communication interface of transaction module 303.

In accordance with one embodiment, at least one of the modules within the first group of platform entities, usually the core module 302 can perform the computation of the technical rules and portfolio allocation weights taking into account of the portfolio leverage levels as discussed in the above sections. Using price and order information feed of all components of the referenced portfolios, the core module 302 can compute the total value of the benchmark indexes and the financial investment instruments and portfolios, and transmit the data tick by tick in market hours back to the members of the second group of platform entities.

In accordance with one embodiment, the price and order flow in the electronic pricing and trading system can be described as: the Exchange platform (310, 311, 312 and 313) posts bid-ask securities or index prices, order volumes and other market index information tick by tick during market hours to its member affiliates through WAN 309 and Global Communication Network 305. Market maker 306 and broker dealer 307 can further post their price and order information through WAN 308 and Global Communication Network 305. The constructor of financial investment instruments, portfolios, or benchmark indexes that are referencing a reference portfolio such as the ALOOP, usually the first group of platform entities, takes the feed of the prices, indexes and orders information through LAN 304 or directly from network interface of transaction module 303. Data server module 301 stores current and historical price and order information feed from LAN 304. Core module 302 utilizes data feed from Data server module 201 through LAN 304 as input and outputs actual or hypothetical transaction instructions to transaction module 303 through LAN 304. After the confirmation of the actual or hypothetical transaction prices from transaction module 303, core module 302 also output values of benchmark indexes and financial investment instruments or portfolios, and their component allocation and values, including option overlays, to market maker 306, broker-dealer/custodian 307 or exchange platforms (310, 311, 312 and 313) through LAN 304, Global Communication Network 305, and WAN 308 and WAN 309.

In accordance with one embodiment, the electronic system and platform can have the functions of both trading transactions and pricing. The pricing of the reference portfolio with said long exposure in equities or equity index and active option overlays might not depend on actual trading transactions. Tick by tick pricing data of component positions of the reference portfolio from Exchange, intermediary and other platforms can still yield accurate values of the benchmark indexes.

### A Practical Model of the Reference Portfolio and Test

In accordance with one embodiment, the technical analysis based dynamic portfolio allocation approach can be extended to include index option writing. A practical model can be introduced with S&P 500 Total Return Index (SPTR) chosen as the underlying stock investment. In one embodiment, instead of using data of specific SPX put or call options, BXM and PUT Indexes are used as building blocks in the portfolio construction to reflect invest-ability. BXM and PUT indexes consider the effects of bid-ask spread of option prices, available strike prices, and average prices from VWAP process for rollover on monthly option expiration Fridays.

Technical Rule: Golden Cross Applied with Buy-Write or Put-Write

Moving Average is one of the most versatile and widely used technical analysis tools for active investment management. First applied in commodities futures trading then for equity index, price moving-average cross signal is the basis of most trending-following system today. Smoothing prices with a time lag, the premise of moving average trend following system is that price momentum exists at certain time scale. The optimal time lag for simple moving average stock market trading system could be related to the time scale of a fundamentals based stochastic market model. Due to uncertainties associated with the theoretical market models, time lag in price moving average is usually determined in practice by empirical analysis or through historical back testing.

Trend following using longer-range moving average becomes advantageous as they can avoid minor corrections or consolidations and ride with the major trend longer. However, it can have more delay in responding to trend reversal.

Market timing with equity index option writing can also be put in the context of a trend following system based on underlying index price moving average. Call writing has a short market exposure which should be used when a down trend is identified from a moving average system. On the other hand, index put writing has a long exposure to market and is thus suitable when index price moving average indicates an up trend.

Besides option price premium related to market momentum, there are directional synergies between moving average trading signal and the index option writing strategy. In trending periods correctly signaled by the moving average, 100% of index option premium become additional income as option expiring in-the-money is avoided. Even when the moving average signal is less successful due to delayed response to trend change, option premium collected can offset a portion of the losses in the underlying equity position. Using moving average with longer time lag can also avoid excessive trading. In a trend-less market, market timing trading intervals that are much longer than a month can take full advantage of the negative Theta of monthly expiring options, such as those in BXM and PUT indexes.

As a popular double moving average cross method, Golden Cross/Black Cross turned out satisfying the requirement of an active index writing scheme on broad market index such as S&P 500 Index. Golden Cross refers to 50 Day Simple (arithmetic) Moving Average (50 DMA) crossing above 200 Day Simple Moving Average (200 DMA), while Black Cross refers to 50 DMA crossing below 200 DMA. Table 1 shows that during a period of 22.6 years (Jun. 1, 1988 to Dec. 31, 2010), Golden Cross and Black Cross on SPTR happened alternately for 21 times. The duration and profit/loss of the last Golden Cross (Oct. 13, 2010) is up to Dec. 31, 2010. Daily close values of SPTR are used. The longest bullish period (from Golden Cross to Black Cross triggers) lasted 1032 trading days (Aug. 31, 1994 to Oct. 1, 1998), while the shortest bullish period only lasted a month (21 trading days between Apr. 19, 2002 and May 20, 2002). The SPTR period returns between Golden Cross and Black Cross trigger days are also listed in Table 1. For bullish period, the Golden Cross signal is indicated as “right” if the period return following the signal (until the next Black Cross triggers) is positive, and “wrong” if otherwise; for bearish period, the Black Cross signal is indicated as “right” if the period return following the signal (until the next Golden Cross triggers) is negative, and “wrong” if otherwise.

Table 2 indicates the effectiveness of the SPTR Golden Cross and Black Cross signals. Golden Cross signals were right nine out of eleven times and a right Golden Cross bullish signal were historically ensued by over-whelming upside (32.8% gain on average) compared to a wrong Golden Cross signal's downside move (an average 5.7% loss). Black Cross signals, though right only three out of ten times, historically can avoid bear market (on average 22.4% loss) every time it is right. Seven wrong Black Cross signals miss on average a market gain each time of 9.5%. The delay in responding to a recovery from bear market seems more serious than delay in exiting a long position before a major market decline. The problematic Black Cross signals were on Sep. 17, 1990, Oct. 1, 1998 (the worst) and Jul. 6, 2010, that during the subsequent 101, 45 and 70 trading sessions, SPTR actually gained 14.8%, 19.6% and 15.3%, respectively.

Table 2 indicates the effectiveness of the SPTR Golden Cross and Black Cross signals. Golden Cross signals were right nine out of eleven times and a right Golden Cross bullish signal were historically ensued by over-whelming upside (32.8% gain on average) compared to a wrong Golden Cross signal's downside move (an average 5.7% loss). Black Cross signals, though right only three out of ten times, historically can avoid bear market (on average 22.4% loss) every time it is right. Seven wrong Black Cross signals miss on average a market gain each time of 9.5%. The delay in responding to a recovery from bear market seems more serious than delay in exiting a long position before a major market decline. The problematic Black Cross signals were on Sep. 17, 1990, Oct. 1, 1998 (the worst) and Jul. 6, 2010, that during the subsequent 101, 45 and 70 trading sessions, SPTR actually gained 14.8%, 19.6% and 15.3%, respectively.

TABLE 1
S&P 500 Total Return Index (SPTR)'s
Golden Crosses and Black Crosses (Jun. 1, 1988-Dec. 31, 2010)

| | | | | Bullish/Bearish |
|---|---|---|---|---|
| Signal | | Duration Till Next Signal | SPTR P/L Till | Signal |
| Trade Date | Type of Signal | (Trading Days) | Next Signal | Right or Wrong |
| Jun. 16, 1988 | Golden Cross (Bullish) | 439 | 32.42% | Right |
| Mar. 13, 1990 | Black Cross (Bearish) | 42 | 5.32% | Wrong |
| May 11, 1990 | Golden Cross (Bullish) | 88 | −8.61% | Wrong |
| Sep. 17, 1990 | Black Cross (Bearish) | 101 | 14.81% | Wrong |
| Feb. 8, 1991 | Golden Cross (Bullish) | 815 | 38.57% | Right |
| May 2, 1994 | Black Cross (Bearish) | 85 | 6.07% | Wrong |
| Aug. 31, 1994 | Golden Cross (Bullish) | 1032 | 126.25% | Right |
| Oct. 1, 1998 | Black Cross (Bearish) | 45 | 19.61% | Wrong |
| Dec. 4, 1998 | Golden Cross (Bullish) | 484 | 24.06% | Right |
| Nov. 3, 2000 | Black Cross (Bearish) | 361 | −19.60% | Right |
| Apr. 19, 2002 | Golden Cross (Bullish) | 21 | −2.81% | Wrong |
| May 20, 2002 | Black Cross (Bearish) | 246 | −11.93% | Right |
| May 12, 2003 | Golden Cross (Bullish) | 326 | 19.59% | Right |
| Aug. 26, 2004 | Black Cross (Bearish) | 43 | 2.11% | Wrong |
| Oct. 27, 2004 | Golden Cross (Bullish) | 439 | 16.39% | Right |
| Jul. 26, 2006 | Black Cross (Bearish) | 24 | 3.06% | Wrong |
| Aug. 29, 2006 | Golden Cross (Bullish) | 335 | 16.27% | Right |
| Dec. 28, 2007 | Black Cross (Bearish) | 370 | −35.55% | Right |
| Jun. 18, 2009 | Golden Cross (Bullish) | 263 | 14.32% | Right |
| Jul. 6, 2010 | Black Cross (Bearish) | 70 | 15.26% | Wrong |
| Oct. 13, 2010 | Golden Cross (Bullish) | 55 | 7.21% | Right |

TABLE 2
Effectiveness of SPTR Golden Crosses and Black Crosses
(Jun. 1, 1988-Dec. 31, 2010)

| | SPTR | SPTR | SPTR | SPTR | SPTR | SPTR |
|---|---|---|---|---|---|---|
| | Golden Crosses | Golden Crosses | Golden Cross | Black Crosses | Black Crosses | Black Cross |
| | (Times) | (Sum of SPTR P/L) | Average P/L | (Times) | (Sum of SPTR P/L) | Average P/L |
| Right | 9 | 295.07% | 32.79% | 3 | −67.08% | −22.36% |
| Wrong | 2 | −11.42% | −5.71% | 7 | 66.25% | 9.46% |

TABLE 3
SPTR Monthly Performance Statistics Following Golden Crosses and Black Crosses (Jun. 1, 1988-Dec. 31, 2010)

| | SPTR | SPTR | SPTR | | SPTR | SPTR | SPTR | |
|---|---|---|---|---|---|---|---|---|
| | Golden Crosses | Golden Crosses | Golden Cross | | Black Crosses | Black Crosses | Black Cross | |
| | (Number of Full | (SPTR Average | Best/Worst | | (Number of Full | (SPTR Average | Best/Worst | |
| | Option Months) | Monthly P/L) | Monthly P/L and Time | | Option Months) | Monthly P/L) | Monthly P/L and Time | |
| Right | 125 | 3.09% | 14.14% | October- | 25 | −6.07% | −24.95% | September- |
| | | | | November 1999 | | | | October 2008 |
| Wrong | 70 | −2.20% | −8.99% | July-August 1990 | 29 | 4.45% | 13.33% | March-April 2009 |

Relevant to index option writing strategies, it is also of interest to examine the monthly performance of SPTR (see Table 3) following the Golden Cross and Black Cross signals. Monthly returns are calculated using daily close values of SPTR from the SPX option expiration Friday of the current month to the option expiration Friday the following month. For example, the September-October 2008 month SPTR return is calculated with close prices on Sep. 19, 2008 and Oct. 17, 2008. Partial months due to a Golden Cross or Black Cross triggering, and also the partial month Dec. 17, 2010 to Dec. 31, 2010, are excluded from the statistics

The monthly returns following a Black Cross appeared to be more volatile than those after a Golden Cross signal. After a Black Cross signal, SPTR index declined in less than half of the months (25 out of 54 months). However, the average monthly decline following a Black Cross is more serious than the monthly gain, and Black Cross signal was able to avoid disastrous month such as September-October 2008. Periods following a Golden Cross signal have a better successful rate at 64% (125 months out of 195) that SPTR index rose. On average, the monthly SPTR gain in a rising month following a Golden Cross is more than the monthly loss of the decline months after a Golden Cross.

In accordance with one embodiment, Golden Cross/Black Cross (GCBC) signal using daily close prices of S&P 500 Total Return Index (SPTR) can be implemented as a simplest tactical portfolio Π_{SPTR} (called SPTR GC-LEO: S&P 500 Total Return Index Golden Cross Long Equity Only strategy):

$${\prod }_{SPTR} = \{ \begin{matrix}SPTR , & when SPTR 50 DMA \geq 200 DMA \\ B , & when SPTR 50 DMA < 200 DMA\end{matrix}$$

Where B represents the position invested in a risk free asset, e.g. the 3-month US Treasury Bills. The SPTR GC-LEO is assumed to have an frictionless trading process: First, at the day of a SPTR Golden Cross (when 50 DMA>200 DMA happens the first day in SPTR daily close price stream), a long position in SPX index is entered at the market close by liquidating all 3-month US Treasury Bills; Second, a long position in SPX (with dividend re-invested daily) is held in days following a Golden Cross as long as SPTR 50 DMA stays above 200 DMA; Third, at market close of the day of a Black Cross (50 DMA<200 DMA), the SPX position is sold completely and invest all proceeds in 3-month US Treasury Bills (with interest re-invested daily); At last, the 3-month Treasury Bills are held as long as 50 DMA stays below 200 DMA for the SPTR Index.

To combine index option writing strategies with the SPTR Golden Cross/Black Cross signal, simply replace the SPTR position in SPTR-GC-LEO strategy with an option writing index such as BXM, PUT or BAT and call the alternative strategies as SPTR-GC-BXM, SPTR-GC-PUT and SPTR-GC-BXY, respectively. In periods following a Golden Cross signal when SPTR-GC-LEO has long SPTR position, the alternative strategies settle expiring index options, write new monthly index options and rebalance portfolio into SPTR or Treasuries Bills, all on option expiring Fridays—just as the respective option writing index does. On the other hand, in the expected bearish periods following a Black Cross, all three alternative strategies hold 3-month T-Bills positions—the same as the SPTR-GC-LEO strategy.

For period of 22.6 years (Jun. 1, 1988-Dec. 31, 2010), Table 4 shows the performance metrics of the SPTR, three passive option writing indexes and four tactical option overlay strategies. Table 5 shows returns of these strategies year by year. The performance metrics of SPTR-GC-LEO indicated effectiveness of the Golden Cross signal. SPTR-GC-LEO had better average annual return than the SPTR with less than 70% of the standard deviation of SPTR and a maximum drawdown within 20%. Despite the largest negative skew and high kurtosis in daily return distribution, SPTR GC-PUT stood out as the best tactical allocation strategy, outperforming SPTR index by 1.7% in annualized return with the lowest risk level at only 42% of SPTR annualized return standard deviation, a beta of 0.25 and a maximum drawdown within 15%. SPTR GC-PUT also achieved the best risk adjusted returns, as measured in Sharpe ratio, Sortino ratio, and the Stutzer Index which penalizes the negative skew common in option based strategies. SPTR GC-BXY did not out-perform SPTR GC-PUT in any performance metrics over the back-tested period. Thus an at-the-money (ATM) put-write is chosen, rather than the out-of-money (OTM) call-write, as a building block for the portfolio model followed.

All performance metrics in Table 4 are calculated from daily return data due to the daily nature of the Golden Cross signal. The risk free rate used is the average annualized yield of 3-month T-bills from Jun. 1, 1988 to Dec. 31, 2010 at 4.15%. The “Stutzer Equivalent Sharpe Ratio” is calculated by \sqrt{252×2×SI} where SI is the Stutzer Index calculated from daily return stream. “Ending Value Multiple” in the last row of Table 4 is the equity curve value of the portfolio on Dec. 31, 2010 assuming starting portfolio value at 1 on Jun. 1, 1988 without any tax, payout, withdrawal or additions. In Table 5, partial year return is used for 1988 (Jun. 1, 1988 to Dec. 31, 1988).

TABLE 4
Indexes and Golden Cross Technical Strategies Performance Metrics Comparison (Jun. 1, 1988-Dec. 31, 2010)

| | | | | | SPTR | SPTR | SPTR | SPTR |
|---|---|---|---|---|---|---|---|---|
| | SPTR | BXM | PUT | BXY | GC-LEO | GC-BXM | GC-PUT | GC-BXY |
| Annualized Return | 9.52% | 9.70% | 11.02% | 10.69% | 11.01% | 10.28% | 11.24% | 11.23% |
| Annualized Std Deviation | 18.25% | 13.06% | 11.90% | 14.57% | 12.50% | 8.96% | 7.74% | 10.15% |
| Sharpe Ratio | 0.294 | 0.426 | 0.577 | 0.450 | 0.549 | 0.685 | 0.917 | 0.698 |
| Sortino Ratio | 0.421 | 0.591 | 0.799 | 0.628 | 0.790 | 0.964 | 1.283 | 0.982 |
| Skew | −0.039 | −0.271 | −0.326 | −0.314 | −0.327 | −0.389 | −0.888 | −0.636 |
| Kurtosis | 9.189 | 26.460 | 29.338 | 14.467 | 6.752 | 40.882 | 24.057 | 10.530 |
| Alpha | 0.00% | 2.15% | 3.80% | 2.48% | 4.34% | 4.61% | 5.76% | 5.15% |
| Beta | 1.000 | 0.635 | 0.571 | 0.757 | 0.469 | 0.284 | 0.250 | 0.360 |
| Stutzer Index (Daily) | 2.670E−04 | 4.249E−04 | 7.018E−04 | 4.779E−04 | 6.490E−04 | 9.193E−04 | 1.542E−03 | 9.605E−04 |
| Stutzer Equivalent | 0.367 | 0.463 | 0.595 | 0.491 | 0.572 | 0.681 | 0.882 | 0.696 |
| Sharpe Ratio | | | | | | | | |
| Maximum Drawdown | 55.25% | 40.14% | 37.09% | 44.83% | 19.19% | 15.36% | 14.36% | 16.90% |
| Ending Value Multiple | 7.803 | 8.111 | 10.610 | 9.937 | 10.589 | 9.137 | 11.113 | 11.083 |

### Construction of Active Leveraged Option Overlay Portfolio (ALOOP)

In accordance with one embodiment, based on Golden Cross/Black Cross signals over an underlying equity index S, a two-state portfolio is proposed that writes ATM put options (P) in an expected bullish period or ATM call options (P) in an expected bearish period. The number of option contracts makes the ATM options' initial face value equal the portfolio's total value. For ALOOP portfolios, the option premium collected at contract initiation are also assumed invested in the underlying equity index and Treasury bills—just as in BXM and PUT indexes. Introducing two parameters of leverage, F_{L} and F_{S}, for the periods following a Golden Cross and a Black Cross respectively, an Active Leveraged Option Overlay Portfolio (ALOOP) H, comprised of equity index S, written European index call or put options, C or P, and a risk free asset (e.g. 3-month T-Bill) B, can be expressed as:

$$\prod = \{ \begin{matrix}{F}_{L} S + ( 1 - {F}_{L} ) B - P , & When 50 DMA \geq 200 DMA on S \\ ( 1 - {F}_{S} ) S + {F}_{S} B - C , & When 50 DMA < 200 DMA on S\end{matrix}$$

where the notation of the F_{L} S and F_{S} B terms means F_{L} and F_{S} portion of the portfolio total value including option premium collected, are invested in stock index and T-bills respectively. This formula can be used to compute the total value of a class of referenced portfolio ALOOP based on market prices of components of underlying equity index S, risk free bond B and active written options overlay P or C, and factors of leverage F_{L} or F_{S}, at any time.

TABLE 5
Indexes and SPTR Golden Cross Tactical Strategies
Year by Year Returns (Jun. 1, 1988-Dec. 31, 2010)

| | | | | | SPTR | SPTR | SPTR | SPTR |
|---|---|---|---|---|---|---|---|---|
| | SPTR | BXM | PUT | BXY | GC-LEO | GC-BXM | GC-PUT | GC-BXY |
| 1988* | 6.33% | 8.13% | 6.90% | 9.76% | 5.28% | 6.36% | 6.90% | 8.46% |
| 1989 | 31.69% | 25.01% | 24.58% | 32.58% | 31.69% | 25.01% | 24.58% | 32.58% |
| 1990 | −3.10% | 3.99% | 8.88% | 1.93% | −9.41% | −2.28% | 1.86% | −5.08% |
| 1991 | 30.47% | 24.39% | 21.32% | 22.93% | 20.27% | 20.16% | 16.75% | 18.38% |
| 1992 | 7.62% | 11.52% | 13.80% | 11.04% | 7.62% | 11.52% | 13.80% | 11.04% |
| 1993 | 10.08% | 14.10% | 14.14% | 11.02% | 10.08% | 14.10% | 14.14% | 11.02% |
| 1994 | 1.32% | 4.50% | 7.10% | 4.60% | −3.05% | 2.43% | 5.50% | −0.05% |
| 1995 | 37.58% | 20.97% | 16.88% | 33.20% | 37.58% | 20.97% | 16.88% | 33.20% |
| 1996 | 22.96% | 15.50% | 16.40% | 19.83% | 22.96% | 15.50% | 16.40% | 19.83% |
| 1997 | 33.36% | 26.64% | 27.68% | 29.75% | 33.36% | 26.64% | 27.68% | 29.75% |
| 1998 | 28.58% | 18.95% | 18.54% | 21.24% | 8.32% | 7.59% | 8.76% | 6.52% |
| 1999 | 20.78% | 21.40% | 20.98% | 19.75% | 20.78% | 21.40% | 20.98% | 19.75% |
| 2000 | −9.10% | 7.40% | 13.06% | 1.96% | −1.03% | 9.97% | 13.26% | 6.85% |
| 2001 | −11.89% | −10.92% | −10.63% | −11.41% | 3.61% | 3.61% | 3.61% | 3.61% |
| 2002 | −22.10% | −7.64% | −8.58% | −12.25% | −1.34% | 0.72% | 1.25% | −0.35% |
| 2003 | 28.68% | 19.37% | 21.77% | 24.91% | 19.53% | 12.67% | 14.73% | 15.36% |
| 2004 | 10.88% | 8.30% | 9.48% | 9.74% | 8.92% | 6.92% | 8.36% | 7.78% |
| 2005 | 4.91% | 4.25% | 6.71% | 4.41% | 4.91% | 4.25% | 6.71% | 4.41% |
| 2006 | 15.79% | 13.33% | 15.16% | 17.14% | 12.90% | 12.27% | 13.88% | 15.13% |
| 2007 | 5.49% | 6.59% | 9.51% | 6.11% | 6.25% | 6.95% | 9.90% | 6.66% |
| 2008 | −37.00% | −28.65% | −26.77% | −31.23% | 1.43% | 1.43% | 1.43% | 1.43% |
| 2009 | 26.46% | 25.91% | 31.51% | 32.07% | 22.89% | 17.20% | 17.95% | 21.25% |
| 2010 | 15.06% | 5.86% | 9.02% | 9.82% | −0.13% | −5.37% | −5.10% | −2.53% |

When Golden Cross signal triggers, the trading transactions are: swapping written call options with writing put options, and exchanging (1−F_{L}−F_{S}) portion of the portfolio value from stock index S holdings which accounted (1−F_{S}) portion of portfolio value to T-bills B. When Black Cross signal triggers, the portfolio transactions are: buy to cover all written put options, sell call option contracts, and liquidate stock index positions which accounted F_{L} portion of portfolio value by amount of (F_{L}+F_{S}−1) portion of the portfolio value to invest in T-bills.

When F_{L}+F_{S}=1, there is no stock index/T-bill exchange trades on signal triggering day. There is possible minor portfolio rebalance adjustment due to market movement since last option expiration Friday.

The meaning of Factor of Leverage F_{L} and F_{S} are clearer by introducing the standard Collateralized Put-Write strategy (CPW=B−P) and Covered Buy-Write (CBW=S−C) strategy as building blocks, and rewrite ALOOP portfolio Π as:

$$\prod = \{ \begin{matrix}CPW + {F}_{L} ( S - B ) , & When 50 DMA \geq 200 DMA on S \\ CBW - {F}_{S} ( S - B ) , & When 50 DMA < 200 DMA on S\end{matrix}$$

In an expected bullish period following a Golden Cross, F_{L} is thus the level of long leverage of a self-financed pair of long stock index/short T-bills, in addition to a fully collateralized put-write strategy. Similarly, F_{S} is the level of short leverage of the self-financed pair of long stock index/short T-bills, in addition to a covered buy-write strategy in an expected bearish period following a Black Cross.

In order to evaluate the portfolio's value and underlying equity exposure (Delta) using a continuous option pricing theory, the ALOOP portfolio model can assume continuous rebalance among three components: S, B, and P or C. However, to use option prices implied in monthly option writing indexes like BXM and PUT when the underlying equity index is SPX, it is more practical to rebalance only on monthly option expiring Fridays and on Golden Cross/Black Cross triggering days. For the Golden Cross/Black Cross signal trigger day rebalance, the shares in stock index, T-bills and number of option contracts are allocated as if they evolved from the rebalanced levels of last monthly option expiration Friday to the signal trigger day. Set the stock index to SPTR, the Golden Cross/Black Cross Active Leverage Option Overlay Portfolio (GCBC-ALOOP), can be written as:

$${\prod }_{SPTR} = \{ \begin{matrix}PUT + {F}_{L} ( SPTR - B ) , & When 50 DMA \geq 200 DMA on SPTR \\ BXM - {F}_{S} ( SPTR - B ) , & When 50 DMA < 200 DMA on SPTR\end{matrix}$$

For performance tracking purpose, this indicates that SPTR GCBC-ALOOP can be constructed from four component indexes: SPTR, BXM, PUT and three-month T-bills B. At time t day close, the daily return of the SPTR GCBC-ALOOP since the previous day t−1 close is:

$${R}_{t} = \{ \begin{matrix}\frac{\begin{matrix}( {PUT}_{t} - {PUT}_{t - 1} ) + \\ {F}_{L} ( {SPTR}_{t} - {SPTR}_{t - 1} ) - {F}_{L} ( {B}_{t} - {B}_{t - 1} )\end{matrix}}{{\prod }_{SPTR} } , & when SPTR 50 DMA \geq 200 DMA \\ \frac{\begin{matrix}( {BXM}_{t} - {BXM}_{t - 1} ) - \\ {F}_{S} ( {SPTR}_{t} - {SPTR}_{t - 1} ) + {F}_{S} ( {B}_{t} - {B}_{t - 1} )\end{matrix}}{{\prod }_{SPTR} } , & when SPTR 50 DMA \geq 200 DMA\end{matrix}$$

where Π_{SPTR} is the portfolio value at time t−1 day close.

### Performance of SPTR GCBC-ALOOP and Special Cases

The back-test of SPTR GCBC-ALOOP starts from Jun. 1, 1988, when PUT and BXM started both with nominal value of 100, and ends on Dec. 31, 2010. On Golden Cross or Black Cross days, SPTR GCBC-ALOOP switches between one share of PUT and BXM, and between long F_{L} share and short F_{S} share of self-financed pair position (SPTR−B). There are 21 Golden Cross/Black cross signal days during the back-tested 22.6 year period. Besides the same monthly option contracts roll-over and portfolio rebalance scheme used in BXM or PUT, it leads to 20 additional trades as one Golden Cross day (Apr. 19, 2002) happened to be an option expiration Friday.

Due to initial and maintenance margin requirements from CBOE on writing SPX index options, the Factor of Leverage F_{L} chosen to be capped at 0.8. Imposing a constraint of no net short position in the stock index, both F_{L} and F_{S} have a lower limit of zero and F_{S} has an upper limit of one. The whole range of two-parameter Factor of Leverage space (F_{L}, F_{S}) are tested with an increment of 0.1 to compare the ex post performance for the entire 22.6 year time span. Table 6 listed annualized returns for all F_{L} and F_{S} combination considered. Table 7-9 compares the risk adjusted returns of Sharpe Ratio, Sortino Ratio and Stutzer Index which is converted to an equivalent annualized Sharpe Ratio, respectively.

The upper limit F_{L} at 0.8 is conservative since CBOE specifies the minimum initial margin for uncovered written SPX put options at only 15% of the contracts' face value plus option premium. CBOE Implied Volatility Index (VIX) needs to be at about 50 for the total 20% margin limit to be hit. The ALOOP portfolio can reduce the SPX put option contracts written to reduce market exposure in high implied volatility environment and to satisfy the margin requirement. For example, for maximum F_{L}=0.8, 20% less SPX put contracts written in PUT for the ALOOP allows VIX going up to about 100 without causing any initial margin problem. At 10% contract face value plus option premium, the maintenance margin of SPX index options is more tolerant such that maximum F_{L}=0.8 can avoid any potential margin call during an option month for ALOOP.

TABLE 6
Annualized Return of SPTR GCBC-ALOOP (Jun. 1, 1988-Dec. 31, 2010)

| | F_{S} | | | | | | | | | | |
|---|---|---|---|---|---|---|---|---|---|---|---|
| F_{L} | 0.0 | 0.1 | 0.2 | 0.3 | 0.4 | 0.5 | 0.6 | 0.7 | 0.8 | 0.9 | 1.0 |
| 0.0 | 10.66% | 10.83% | 10.98% | 11.11% | 11.23% | 11.32% | 11.39% | 11.45% | 11.48% | 11.50% | 11.49% |
| 0.1 | 11.37% | 11.55% | 11.69% | 11.83% | 11.94% | 12.04% | 12.11% | 12.16% | 12.20% | 12.21% | 12.21% |
| 0.2 | 12.07% | 12.25% | 12.42% | 12.56% | 12.65% | 12.74% | 12.82% | 12.87% | 12.91% | 12.92% | 12.92% |
| 0.3 | 12.77% | 12.95% | 13.12% | 13.26% | 13.39% | 13.50% | 13.55% | 13.57% | 13.61% | 13.62% | 13.62% |
| 0.4 | 13.46% | 13.64% | 13.81% | 13.95% | 14.08% | 14.19% | 14.28% | 14.36% | 14.45% | 14.32% | 14.31% |
| 0.5 | 14.13% | 14.32% | 14.49% | 14.63% | 14.76% | 14.87% | 14.97% | 15.04% | 15.10% | 15.14% | 15.17% |
| 0.6 | 14.81% | 14.99% | 15.16% | 15.31% | 15.44% | 15.55% | 15.64% | 15.72% | 15.78% | 15.82% | 15.84% |
| 0.7 | 15.47% | 15.66% | 15.82% | 15.97% | 16.10% | 16.22% | 16.31% | 16.39% | 16.44% | 16.49% | 16.51% |
| 0.8 | 16.12% | 16.31% | 16.48% | 16.63% | 16.76% | 16.87% | 16.97% | 17.04% | 17.10% | 17.14% | 17.17% |

TABLE 7
Sharpe Ratio of SPTR GCBC-ALOOP (Jun. 1, 1988-Dec. 31, 2010)

| | F_{S} | | | | | | | | | | |
|---|---|---|---|---|---|---|---|---|---|---|---|
| F_{L} | 0.0 | 0.1 | 0.2 | 0.3 | 0.4 | 0.5 | 0.6 | 0.7 | 0.8 | 0.9 | 1.0 |
| 0.0 | 0.5314 | 0.5893 | 0.6500 | 0.7108 | 0.7674 | 0.8138 | 0.8435 | 0.8519 | 0.8379 | 0.8051 | 0.7592 |
| 0.1 | 0.5563 | 0.6122 | 0.6634 | 0.7178 | 0.7660 | 0.8046 | 0.8291 | 0.8364 | 0.8258 | 0.7996 | 0.7616 |
| 0.2 | 0.5746 | 0.6256 | 0.6762 | 0.7238 | 0.7586 | 0.7919 | 0.8123 | 0.8187 | 0.8107 | 0.7897 | 0.7584 |
| 0.3 | 0.5876 | 0.6339 | 0.6787 | 0.7202 | 0.7557 | 0.7830 | 0.7972 | 0.8008 | 0.7947 | 0.7777 | 0.7518 |
| 0.4 | 0.5965 | 0.6382 | 0.6780 | 0.7142 | 0.7448 | 0.7682 | 0.7828 | 0.7879 | 0.7913 | 0.7649 | 0.7432 |
| 0.5 | 0.6021 | 0.6398 | 0.6752 | 0.7069 | 0.7335 | 0.7537 | 0.7665 | 0.7712 | 0.7680 | 0.7574 | 0.7501 |
| 0.6 | 0.6052 | 0.6392 | 0.6708 | 0.6988 | 0.7221 | 0.7398 | 0.7510 | 0.7555 | 0.7532 | 0.7445 | 0.7303 |
| 0.7 | 0.6063 | 0.6371 | 0.6654 | 0.6903 | 0.7109 | 0.7265 | 0.7366 | 0.7408 | 0.7392 | 0.7320 | 0.7200 |
| 0.8 | 0.6060 | 0.6340 | 0.6594 | 0.6816 | 0.7000 | 0.7139 | 0.7230 | 0.7269 | 0.7259 | 0.7200 | 0.7097 |

As shown in the Table 6, annualized returns increase monotonically with F_{L} and F_{S} except some minor exceptions at F_{L}≦0.4 and F_{S}≧0.9. SPTR GCBC-ALOOP (F_{L}=0.8 F_{S}=1) has the best annualized return of 17.17%. However, improvement in returns is much more sensitive to F_{L} than to F_{S}. This might be explained by the fact that signals from Golden Crosses have better chance to be “right” and are more profitable than those from Black Crosses, as indicated in Table 2 and 3.

TABLE 8
Sortino Ratio of SPTR GCBC-ALOOP (Jun. 1, 1988-Dec. 31, 2010)

| | F_{S} | | | | | | | | | | |
|---|---|---|---|---|---|---|---|---|---|---|---|
| F_{L} | 0.0 | 0.1 | 0.2 | 0.3 | 0.4 | 0.5 | 0.6 | 0.7 | 0.8 | 0.9 | 1.0 |
| 0.0 | 0.7274 | 0.8056 | 0.8877 | 0.9705 | 1.0481 | 1.1125 | 1.1539 | 1.1652 | 1.1444 | 1.0971 | 1.0325 |
| 0.1 | 0.7628 | 0.8384 | 0.9082 | 0.9831 | 1.0498 | 1.1037 | 1.1381 | 1.1480 | 1.1320 | 1.0938 | 1.0397 |
| 0.2 | 0.7897 | 0.8591 | 0.9281 | 0.9938 | 1.0426 | 1.0902 | 1.1190 | 1.1278 | 1.1154 | 1.0844 | 1.0393 |
| 0.3 | 0.8095 | 0.8728 | 0.9345 | 0.9920 | 1.0421 | 1.0811 | 1.1018 | 1.1066 | 1.0970 | 1.0717 | 1.0340 |
| 0.4 | 0.8237 | 0.8812 | 0.9363 | 0.9869 | 1.0303 | 1.0639 | 1.0853 | 1.0930 | 1.0972 | 1.0574 | 1.0256 |
| 0.5 | 0.8334 | 0.8856 | 0.9349 | 0.9795 | 1.0175 | 1.0467 | 1.0654 | 1.0726 | 1.0681 | 1.0528 | 1.0410 |
| 0.6 | 0.8396 | 0.8869 | 0.9312 | 0.9708 | 1.0043 | 1.0299 | 1.0465 | 1.0532 | 1.0499 | 1.0373 | 1.0169 |
| 0.7 | 0.8430 | 0.8861 | 0.9259 | 0.9613 | 0.9910 | 1.0137 | 1.0285 | 1.0348 | 1.0324 | 1.0220 | 1.0046 |
| 0.8 | 0.8442 | 0.8835 | 0.9196 | 0.9514 | 0.9779 | 0.9982 | 1.0115 | 1.0174 | 1.0158 | 1.0071 | 0.9922 |

TABLE 9
Stutzer Equivalent Sharpe Ratio of SPTR GCBC-ALOOP (Jun. 1, 1988-Dec. 31, 2010)

| | F_{S} | | | | | | | | | | |
|---|---|---|---|---|---|---|---|---|---|---|---|
| F_{L} | 0.0 | 0.1 | 0.2 | 0.3 | 0.4 | 0.5 | 0.6 | 0.7 | 0.8 | 0.9 | 1.0 |
| 0.0 | 0.5547 | 0.6031 | 0.6543 | 0.7061 | 0.7546 | 0.7946 | 0.8202 | 0.8275 | 0.8157 | 0.7877 | 0.7485 |
| 0.1 | 0.5797 | 0.6261 | 0.6690 | 0.7150 | 0.7558 | 0.7887 | 0.8097 | 0.8160 | 0.8072 | 0.7851 | 0.7531 |
| 0.2 | 0.5990 | 0.6410 | 0.6830 | 0.7228 | 0.7520 | 0.7802 | 0.7975 | 0.8030 | 0.7964 | 0.7790 | 0.7529 |
| 0.3 | 0.6137 | 0.6514 | 0.6883 | 0.7226 | 0.7523 | 0.7751 | 0.7871 | 0.7901 | 0.7852 | 0.7713 | 0.7500 |
| 0.4 | 0.6248 | 0.6586 | 0.6910 | 0.7207 | 0.7459 | 0.7653 | 0.7776 | 0.7821 | 0.7852 | 0.7631 | 0.7456 |
| 0.5 | 0.6332 | 0.6634 | 0.6919 | 0.7177 | 0.7394 | 0.7561 | 0.7667 | 0.7708 | 0.7686 | 0.7603 | 0.7546 |
| 0.6 | 0.6395 | 0.6665 | 0.6917 | 0.7143 | 0.7331 | 0.7475 | 0.7568 | 0.7607 | 0.7592 | 0.7526 | 0.7416 |
| 0.7 | 0.6443 | 0.6685 | 0.6909 | 0.7107 | 0.7272 | 0.7398 | 0.7480 | 0.7516 | 0.7507 | 0.7454 | 0.7362 |
| 0.8 | 0.6479 | 0.6697 | 0.6896 | 0.7071 | 0.7217 | 0.7328 | 0.7402 | 0.7436 | 0.7430 | 0.7388 | 0.7311 |

Given the range of F_{L} and F_{S}, Stutzer Index changes very slightly the rankings of SPTR GCBC-ALOOP portfolios from those based on Sharpe Ratio or Sortino Ratio. SPTR GCBC-ALOOP (F_{L}=0, F_{S}=0.7) is about the portfolio that achieves the best risk-adjusted returns, which, however, are still less than those of SPTR GC-PUT in Table 4.

Fixing F_{L}, best risk-adjusted returns (Sharpe ratio, Sortino ratio or Stutzer Index) are achieved at F_{S}˜0.7. Fixing F_{S}, risk-adjusted returns increase with F_{L} when F_{S}<0.2, but decrease with F_{L} when F_{S}>0.3. At F_{S}=0.2˜0.3, risk adjusted returns are largely stable regardless of F_{L}. SPTR GCBC-ALOOP (F_{L}=0.8, F_{S}=0.2) has the best annualized return of 16.5% when F_{S} is fixed to 0.2. It is among the limited range of SPTR GCBC-ALOOP cases that are feasible for implementation in a structured investment structure. ETF generally disallows holding more than 20˜25% cash or cash equivalent which means F_{L}≧0.75˜0.8 and F_{S}≦0.2˜0.25. On the other hand, SPX option margin requirement sets F_{L}≦0.8. With excellent historical return and risk-adjusted return characteristics, SPTR GCBC-ALOOP (F_{L}=0.8, F_{S}=0.2) also has no need to do sizable portfolio re-allocation between stock and cash on signal switching days as it satisfies F_{L}+F_{S}=1. Nominally, it is a simple 80% stock index plus 20% cash passive investment portfolio, only actively overlaid with written index options—shorting puts or calls depending on a Golden Cross/Black Cross bullish or bearish trend prediction.

SPTR GCBC-ALOOP (F_{L}=0.5, F_{S}=0.5) is another nominal passive portfolio with a moderate 50% stock index/50% cash allocation, and additionally actively overlaid with written index options. SPTR GCBC-ALOOP (F_{L}=0, F_{S}=1) is holding 100% T-bills while actively writing SPX puts or calls to derive income—an option overlay cash management portfolio. Along with SPTR GCBC-ALOOP (F_{L}=0.8, F_{S}=0.2), these two special cases of SPTR GCBC-ALOOP have no stock index/T-bills exchange trades beyond portfolio rebalance as needed. For benchmark purpose, SPTR GCBC-ALOOP (F_{L}=0, F_{S}=0) is also examined, which simply switches between BXM and PUT indexes according to the Golden Cross and Black Cross signals with 100% stock index/T-bills swap.

Performance metrics and yearly returns during Jun. 1, 1988-Dec. 31, 2010 for SPTR GCBC-ALOOP special cases are presented in Table 10 and 11, respectively. With the best annualized return record, SPTR GCBC-ALOOP (F_{L}=0.8 F_{S}=1) turn 1$ on Jun. 1, 1988 into 35.92$ on Dec. 31, 2010, barring any withdrawal, addition or taxes from the portfolio. In comparison, SPTR only turned a multiple of 7.803 for the period.

On risk measures, SPTR GCBC-ALOOP (F_{L}=0.8 F_{S}=1) has about the same standard deviation as the SPTR, but experienced a maximum drawdown within 30%—only about 55% that of the SPTR. All the special cases of SPTR GCBC-ALOOP in Table 10 delivered better annualized return than SPTR during the period of 22.6 years, with less maximum drawdown and better risk-adjusted return measures. From yearly returns of Table 5 and Table 11, however, SPTR out-performed all cases of SPTR GCBC-ALOOP, Golden Cross technical strategies and option writing indexes in the year 1998 and 2010. However, in the two preceding years, 1997 and 2009, SPTR GCBC-ALOOP (F_{L}=0.8, F_{S}=0.2) out-performed SPTR by over 20% in return each year.

TABLE 10
Performance Metrics of SPTR GCBC-ALOOP Cases (Jun. 1, 1988-Dec. 31, 2010)

| | SPTR | SPTR | SPTR | SPTR | SPTR | SPTR |
|---|---|---|---|---|---|---|
| | GCBC-ALOOP | GCBC-ALOOP | GCBC-ALOOP | GCBC-ALOOP | GCBC-ALOOP | GCBC-ALOOP |
| | (F_{L} = 0.5, F_{S} = 0.5) | (F_{L} = 0, F_{S} = 1) | (F_{L} = 0.8, F_{S} = 1) | (F_{L} = 0.8, F_{S} = 0.2) | (F_{L} = 0, F_{S} = 0.7) | (F_{L} = 0, F_{S} = 0) |
| Annualized Return | 14.88% | 11.49% | 17.17% | 16.48% | 11.45% | 10.66% |
| Annualized Std Deviation | 14.24% | 9.68% | 18.35% | 18.71% | 8.57% | 12.26% |
| Sharpe Ratio | 0.754 | 0.759 | 0.710 | 0.659 | 0.852 | 0.531 |
| Sortino Ratio | 1.077 | 1.064 | 1.018 | 0.941 | 1.208 | 0.737 |
| Skew | −0.627 | −0.723 | −0.501 | −0.504 | −0.761 | −0.407 |
| Kurtosis | 13.344 | 14.751 | 11.290 | 11.013 | 17.001 | 26.746 |
| Alpha | 7.67% | 6.97% | 10.59% | 7.65% | 6.07% | 3.29% |
| Beta | 0.570 | 0.070 | 0.454 | 0.873 | 0.229 | 0.600 |
| Stutzer Index (Daily) | 1.134E−03 | 1.112E−03 | 1.061E−03 | 9.435E−04 | 1.359E−03 | 6.105E−04 |
| Stutzer Equivalent | 0.756 | 0.749 | 0.731 | 0.690 | 0.828 | 0.555 |
| Sharpe Ratio | | | | | | |
| Maximum Drawdown | 23.01% | 16.80% | 29.69% | 31.82% | 14.36% | 40.21% |
| Ending Portfolio Value | 22.975 | 11.689 | 35.920 | 31.432 | 11.586 | 9.865 |

The monthly options roll-over, portfolio-rebalance (same as the methodology of BXM and PUT indexes), and technical rule triggered trades, can make transaction cost a potential performance drag for SPTR GCBC-ALOOP. For special cases of SPTR GCBC-ALOOP with leverage parameters F_{L}+F_{S}=1, the technical rule triggered trades only involve put/call options swap and portfolio rebalance without any fixed size equity index and T-bills exchange. From Jun. 1, 1988 to Dec. 31, 2010, 271 times portfolio rebalancing and option roll-over are needed at monthly option expiration Fridays and there were 20 market timing trades of swapping written puts and calls on Golden Cross/Black Cross days—a total of 291 times of trading in 22.6 years.

TABLE 11
Yearly Returns of SPTR GCBC-ALOOP Special Cases (Jun. 1, 1988-Dec. 31, 2010)

| | SPTR | SPTR | SPTR | SPTR | SPTR | SPTR |
|---|---|---|---|---|---|---|
| | GCBC-ALOOP | GCBC-ALOOP | GCBC-ALOOP | GCBC-ALOOP | GCBC-ALOOP | GCBC-ALOOP |
| | (F_{L} = 0.5, F_{S} = 0.5) | (F_{L} = 0, F_{S} = 1) | (F_{L} = 0.8, F_{S} = 1) | (F_{L} = 0.8, F_{S} = 0.2) | (F_{L} = 0, F_{S} = 0.7) | (F_{L} = 0, F_{S} = 0) |
| 1988* | 8.41% | 7.53% | 7.87% | 8.74% | 7.89% | 8.68% |
| 1989 | 37.00% | 24.58% | 44.89% | 44.89% | 24.58% | 24.58% |
| 1990 | −4.42% | 0.94% | −12.85% | −7.81% | 3.25% | 8.40% |
| 1991 | 23.56% | 11.30% | 22.77% | 31.58% | 14.13% | 20.87% |
| 1992 | 15.93% | 13.80% | 17.15% | 17.15% | 13.80% | 13.80% |
| 1993 | 17.90% | 14.14% | 20.18% | 20.18% | 14.14% | 14.14% |
| 1994 | 1.29% | 2.89% | −3.27% | 0.27% | 4.31% | 7.62% |
| 1995 | 33.19% | 16.88% | 43.93% | 43.93% | 16.88% | 16.88% |
| 1996 | 25.68% | 16.40% | 31.42% | 31.42% | 16.40% | 16.40% |
| 1997 | 43.54% | 27.68% | 53.63% | 53.63% | 27.68% | 27.68% |
| 1998 | 11.58% | 0.96% | 2.29% | 18.07% | 6.47% | 20.24% |
| 1999 | 29.50% | 20.98% | 34.39% | 34.39% | 20.98% | 20.98% |
| 2000 | 11.16% | 20.09% | 13.04% | 5.83% | 17.27% | 10.62% |
| 2001 | −3.50% | 2.96% | 2.50% | −7.80% | −0.94% | −10.92% |
| 2002 | 2.95% | 15.03% | 13.19% | −4.79% | 8.59% | −7.15% |
| 2003 | 27.24% | 12.07% | 28.38% | 36.77% | 15.04% | 21.55% |
| 2004 | 12.63% | 7.71% | 13.82% | 15.52% | 8.34% | 9.75% |
| 2005 | 7.40% | 6.71% | 7.67% | 7.67% | 6.71% | 6.71% |
| 2006 | 17.63% | 12.03% | 18.57% | 21.05% | 12.91% | 14.96% |
| 2007 | 10.55% | 10.32% | 11.12% | 10.49% | 10.08% | 9.54% |
| 2008 | −9.17% | 9.63% | 11.73% | −21.06% | −1.90% | −28.65% |
| 2009 | 37.73% | 20.20% | 42.52% | 47.87% | 22.87% | 26.72% |
| 2010 | −1.63% | −8.23% | −8.99% | 2.18% | −4.04% | 6.16% |

Assuming an f basis points of total portfolio value as the cost to cover the spreads in SPX options transactions, commission fees for options and rebalancing equity index and T-bill, f basis points loss is considered as the total market friction cost before tax, fee and any potential market impact, for every one of 291 trading days for any SPTR GCBC-ALOOP with F_{L}+F_{S}=1. For f=5 bp, 10 bp, 15 bp and 20 bp, performance metrics of three special cases of SPTR GCBC-ALOOP are presented in Table 11(a-c), all for the time period Jun. 1, 1988 to Dec. 31, 2010.

Table 11(a) shows that with similar level of annualized return standard deviations, SPTR GCBC-ALOOP (F_{L}=0.8, F_{S}=0.2) has returned over 4% more per year on average than SPTR even charged with large market friction level of f=20 bp. Despite a market friction load of f=15 bp, SPTR GCBC-ALOOP (F_{L}=0, F_{S}=1) was able to delivered a similar annualized average return as SPTR with slightly over half of the return standard deviation of SPTR, as indicated in Table 11(b).

As shown in Table 11(c), even at estimated market friction of f=20 bp, the SPTR GCBC-ALOOP (F_{L}=0.5, F_{S}=0.5) out-performed SPTR and SPTR GC-LEO by 0.95% in annualized returns and matched SPTR GC-LEO in risk-adjusted returns. As an active benchmark portfolio, SPTR GC-LEO will be compared to SPTR GCBC-ALOOP (F_{L}=0.5, F_{S}=0.5) based on similar Delta exposure.

TABLE 11 (a)
Market Friction Effect on SPTR GCBC-ALOOP (F_{L} = 0.8, F_{S} = 0.2)

| | | SPTR GCBC-ALOOP (F_{L} = 0.8, F_{S} = 0.2) | | | | |
|---|---|---|---|---|---|---|
| | SPTR | f = 0 bp | f = 5 bp | f = 10 bp | f = 15 bp | f = 20 bp |
| Annualized Return | 9.52% | 16.48% | 15.74% | 15.00% | 14.26% | 13.53% |
| Annualized Std Deviation | 18.25% | 18.71% | 18.72% | 18.73% | 18.74% | 18.75% |
| Sharpe Ratio | 0.294 | 0.659 | 0.619 | 0.579 | 0.540 | 0.500 |
| Sortino Ratio | 0.421 | 0.941 | 0.882 | 0.824 | 0.767 | 0.710 |
| Alpha | 0.00 | 7.65% | 6.90% | 6.16% | 5.42% | 4.69% |
| Beta | 1.000 | 0.8727 | 0.8731 | 0.8734 | 0.8738 | 0.8742 |
| Stutzer Equivalent | 0.367 | 0.690 | 0.655 | 0.621 | 0.587 | 0.552 |
| Sharpe Ratio | | | | | | |
| Maximum Drawdown | 55.25% | 31.82% | 32.40% | 32.97% | 33.53% | 34.09% |
| Ending Portfolio Value | 7.80 | 31.43 | 27.19 | 23.52 | 20.34 | 17.59 |

TABLE 11 (b)
Market Friction Effect on SPTR GCBC-ALOOP (F_{L} = 0, F_{S} = 1)

| | | SPTR GCBC-ALOOP (F_{L} = 0, F_{S} = 1 ) | | | | |
|---|---|---|---|---|---|---|
| | SPTR | f = 0 bp | f = 5 bp | f = 10 bp | f = 15 bp | f = 20 bp |
| Annualized Return | 9.52% | 11.49% | 10.78% | 10.07% | 9.36% | 8.66% |
| Annualized Std Deviation | 18.25% | 9.68% | 9.68% | 9.69% | 9.70% | 9.71% |
| Sharpe Ratio | 0.294 | 0.759 | 0.685 | 0.611 | 0.538 | 0.465 |
| Sortino Ratio | 0.421 | 1.064 | 0.958 | 0.853 | 0.748 | 0.645 |
| Alpha | 0.00 | 6.97% | 6.26% | 5.54% | 4.84% | 4.13% |
| Beta | 1.00 | 0.0696 | 0.0698 | 0.0700 | 0.0703 | 0.0705 |
| Stutzer Equivalent | 0.367 | 0.749 | 0.683 | 0.616 | 0.550 | 0.484 |
| Sharpe Ratio | | | | | | |
| Maximum Drawdown | 55.25% | 16.80% | 17.13% | 17.47% | 17.80% | 18.13% |
| Ending Portfolio Value | 7.80 | 11.69 | 10.11 | 8.74 | 7.55 | 6.53 |

TABLE 11 (c)
Market Friction Effect on SPTR GCBC-ALOOP (F_{L} = 0.5, F_{S} = 0.5)

| | | SPTR GCBC-ALOOP (F_{L} = 0.5, F_{S}= 0.5) | | | | |
|---|---|---|---|---|---|---|
| | SPTR | f = 0 bp | f = 5 bp | f = 10 bp | f = 15 bp | f = 20 bp |
| Annualized Return | 9.52% | 14.88% | 14.14% | 13.41% | 12.68% | 11.96% |
| Annualized Std Deviation | 18.25% | 14.24% | 14.25% | 14.26% | 14.27% | 14.28% |
| Sharpe Ratio | 0.294 | 0.754 | 0.702 | 0.650 | 0.598 | 0.547 |
| Sortino Ratio | 0.421 | 1.077 | 1.001 | 0.925 | 0.851 | 0.777 |
| Alpha | 0.00 | 7.67% | 6.94% | 6.20% | 5.48% | 4.75% |
| Beta | 1.000 | 0.5695 | 0.5697 | 0.5700 | 0.5702 | 0.5704 |
| Stutzer Equivalent | 0.367 | 0.756 | 0.711 | 0.666 | 0.621 | 0.576 |
| Sharpe Ratio | | | | | | |
| Maximum Drawdown | 55.25% | 23.01% | 23.09% | 23.17% | 23.25% | 23.33% |
| Ending Portfolio Value | 7.80 | 22.97 | 19.87 | 17.19 | 14.86 | 12.85 |

### Delta, Return Attribution and Risk Management for SPTR GCBC-ALOOP

Under Black-Scholes Option Pricing Theory, the Delta of a European call option is: δ_{BS}=exp[−q·T]·N(d₁) where q denotes the continuous dividend yield, T is the time to expiration,

$$N ( {d}_{1} ) = \frac{1}{\sqrt{2 π}} {\int }_{- ∞}^{{d}_{1}} exp ( - {x}^{2} / 2 ) d x$$

and d₁=[ln(S/K)+(r_{f}−q)]/(σ_{BS}\sqrt{T})+σ_{BS}\sqrt{T}/2 in which K is the strike price and σ_{BS} is the Black-Scholes implied volatility.

The call option Delta can be written as:

$$δ = {δ}_{BS} + \frac{\partial C}{\partial {σ}_{BS}} \cdot \frac{\partial {σ}_{BS}}{\partial S} where the \frac{\partial {σ}_{BS}}{\partial S} \approx \frac{\partial {σ}_{BS}}{\partial K}$$

represents the volatility skew and

$$\frac{\partial C}{\partial {σ}_{BS}} = v = \frac{1}{\sqrt{2 π}} S \sqrt{T} exp [ - {d}_{1}^{2} / 2 - q \cdot T ]$$

For the case of at the money call K=S, thus d₁ is reduced to:

d̅₁=(r_{f}−q)/(σ_{BS}\sqrt{T})+σ_{BS}\sqrt{T}/2

Look at the short maturity option delta at about one month before expiration: T˜ 1/12 year:

$$δ = {A}_{0} + {A}_{1} \cdot ( {σ}_{BS} \sqrt{T} ) \cdot ( \frac{\partial ln {σ}_{BS}}{\partial ln S} )$$

where

$$\frac{\partial ln {σ}_{BS}}{\partial ln S}$$

is directly related to the volatility skew level and two coefficients A₁ and A₀ are defined as:

$${A}_{0} = \frac{exp ( - q \cdot T )}{\sqrt{2 π}} {\int }_{- ∞}^{{\overline{d}}_{1}} exp ( - \frac{{x}^{2}}{2} ) \cdot d x = exp ( - q \cdot T ) \cdot erfc ( {\overline{d}}_{1} )$$

$${A}_{1} = \frac{1}{\sqrt{2 π}} exp ( - q \cdot T - {\overline{d}}_{1}^{2} / 2 )$$

For SPX call options, σ_{BS}≈20.0% from the arithmetic average of VIX daily close of option expiration Fridays from Jan. 19, 1990 to Dec. 17, 2010, is taken as the surrogate of implied volatility σ_{BS}. Other parameters can be estimated for the period as r_{f}=3.82% using annualized 3-month T-bill return; and q=2.30% which is calculated through the difference between annualized returns of SPTR and SPX However, with the expression of d̅₁ changed signs multiple times due to the relationship between risk free rate r_{f} and on-going SPX dividend yield q in the past 21 years, a neutral estimate of d̅₁ is taken as zero that leads to: A₀≈½ and

$${A}_{1} \approx \frac{1}{\sqrt{2 π}} .$$

Delta is simplified as:

$$δ \approx \frac{1}{2} - \frac{1}{\sqrt{2 π}} \cdot ( {σ}_{BS} \sqrt{T} ) \cdot ( \frac{\partial ln {σ}_{BS}}{\partial ln S} )$$

Thus

$$\frac{\partial ln {σ}_{BS}}{\partial ln S} ,$$

the slope or logarithmic volatility skew becomes critical to determine Delta for at the money call options. Absence of volatility skew (i.e. when the implied volatility is independent of underlying equity index or strike price), the nominal Delta of the short term with one month to maturity for a call or put option is about 0.5. Using VIX and SPX index daily close values on option expiration Fridays every month, estimate its value as:

$${( \frac{Δ ln {σ}_{BS}}{Δln S} )}_{n} = \frac{ln {VIX}_{n + 1} - ln {VIX}_{n}}{ln {S}_{n + 1} - ln {S}_{n}}$$

where the subscripts n and n+1 denote consecutive monthly option expiration Friday close values.

Excluding the months that month-to-month SPX change is less than 1% which are considered as singularity situations for

$$\frac{\partial ln {σ}_{BS}}{\partial ln S} ,$$

the history and distribution of 198 monthly discrete

$$\frac{\partial ln {σ}_{BS}}{\partial ln S}$$

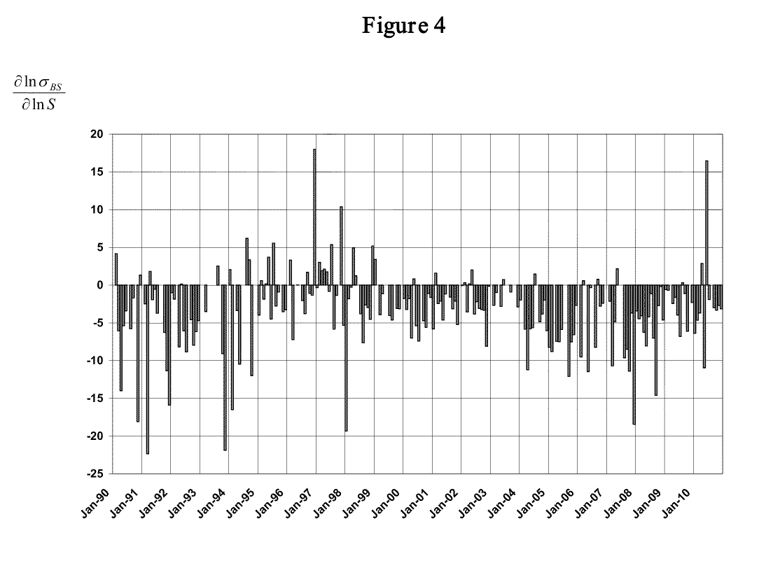

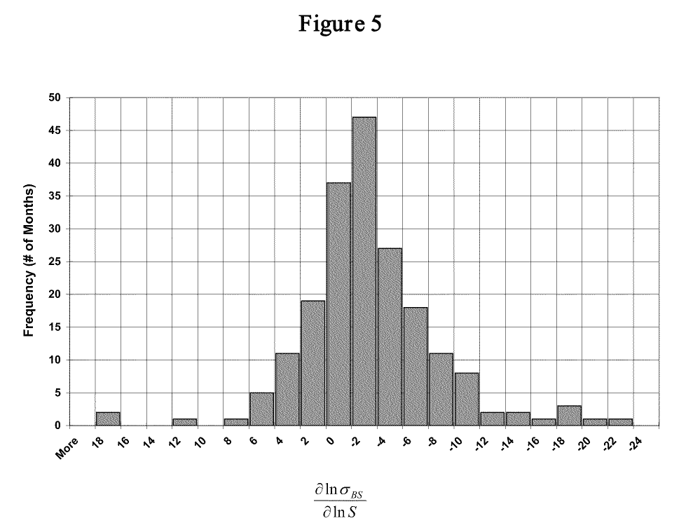

estimations are shown in FIG. 4 and FIG. 5, with a mean of −3.45 Thus δ˜0.420 for the 21 year period from Jan. 19, 1990 to Dec. 17, 2010.

Historical monthly estimations of

$${σ}_{BS} \frac{\partial ln {σ}_{BS}}{\partial ln S}$$

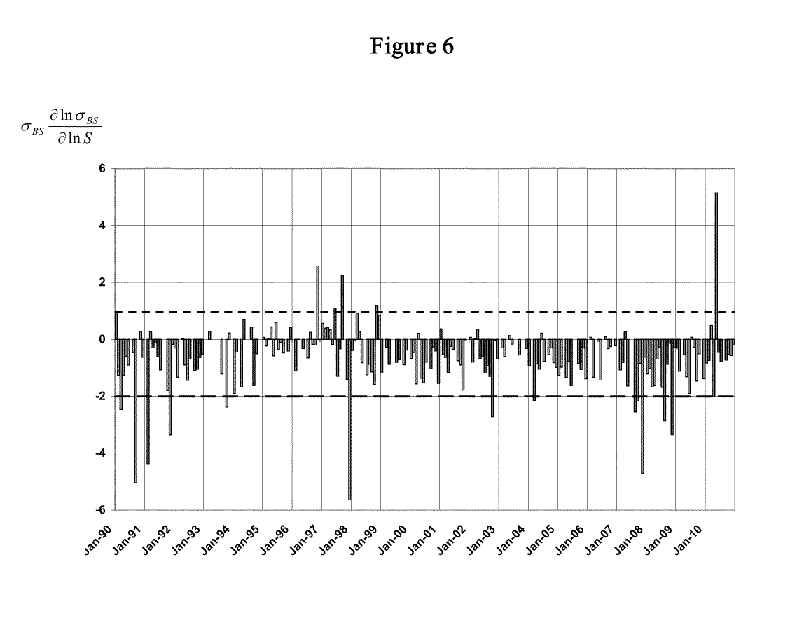

for SPX over the same period are shown in FIG. 6.

$${σ}_{BS} \frac{\partial ln {σ}_{BS}}{\partial ln S} < - 2 and {σ}_{BS} \frac{\partial ln {σ}_{BS}}{\partial ln S} > 1$$

appear as the statistical outliers with the two levels marked as dotted lines in FIG. 6. Estimated value of

$${σ}_{BS} \frac{\partial ln {σ}_{BS}}{\partial ln S}$$

can be used as risk control threshold to avoid tail event losses in index option writing strategies such as PUT and BXM. Both PUT and BXM have the same nominal equity index exposure of

$$\frac{1}{2} - \sqrt{\frac{T}{2 π}} \cdot ( {σ}_{BS} \frac{\partial ln {σ}_{BS}}{\partial ln S} ) ,$$

despite that both could be slightly out-of-money and δ_{BXM}>δ_{PUT}, because d₁> d̅₁ for PUT index and d₁< d̅₁ for BXM index.

Further separating the 198 monthly estimations of

$$\frac{\partial ln {σ}_{BS}}{\partial ln S} and {σ}_{BS} \frac{\partial ln {σ}_{BS}}{\partial ln S}$$

according to SPTR periods following Golden Cross/Black Cross and their positive/negative value, their average values are listed for various groupings in Table 12, where Jan. 14, 2011 closing values of VIX and SPX are also used to estimate the monthly values backward for Dec. 17, 2010.

TABLE 12
Golden Cross/Black Cross, Positive or Negative Volatility Skew and Averages
Over Jan. 19, 1990 to Dec. 17, 2010

| Number of Months (SPX change > 1%) | Number of Months Followwing Signal of | Number of Months with Volatility Skew | Average $\frac{\partial ln {σ}_{BS}}{\partial ln S}$ | Average ${σ}_{BS} \frac{\partial ln {σ}_{BS}}{\partial ln S}$ |
|---|---|---|---|---|
| Total: 198 | | | −3.45 | −0.68 |
| | Golden Cross: 144 | | −3.55 | −0.62 |
| | | Negative: 112 | −5.51 | −0.98 |
| | | Positive: 32 | 3.32 | 0.66 |
| | Black Cross: 54 | | −3.21 | −0.85 |
| | | Negative: 47 | −4.08 | −1.05 |
| | | Positive: 7 | 2.6 | 0.47 |

When

$${σ}_{BS} \frac{\partial ln {σ}_{BS}}{\partial ln S} \leq - 2$$

at a monthly option expiring Friday close, nominal Delta of a written SPX put option increases from 0.5 to 0.73. This is an unfavorable change in market exposure when SPX is declining. On the other hand, when SPX is rising and

$${σ}_{BS} \frac{\partial ln {σ}_{BS}}{\partial ln S} > 1$$

at an option expiring Friday close, nominal Delta of a SPX covered call strategy such as the BXM index decreases from 0.5 to 0.385—an unfavorable change in SPX exposure if underlying index SPX rises.

The Greek Letter Delta of the GCBC-ALOOP can be written as:

$$Δ = \frac{\partial Π}{\partial S} = \{ \begin{matrix}( 1 + {F}_{L} ) - δ , & When 50 DMA \geq 200 DMA on S \\ ( 1 - {F}_{S} ) - δ , & When 50 DMA < 200 DMA on S\end{matrix}$$

where δ is Delta of the European call option. At monthly option expiration day or shortly after, portfolio Delta can be written approximately as:

$$Δ = \frac{\partial Π}{\partial S} \approx \{ \begin{matrix}( \frac{1}{2} + {F}_{L} ) - \frac{1}{\sqrt{2 π}} {σ}_{BS} \sqrt{T} \cdot \frac{\partial ln {σ}_{BS}}{\partial ln S} , & when S : 200 DMA \leq 50 DMA \\ ( \frac{1}{2} - {F}_{S} ) - \frac{1}{\sqrt{2 π}} {σ}_{BS} \sqrt{T} \cdot \frac{\partial ln {σ}_{BS}}{\partial ln S} , & when S : 200 DMA > 50 DMA\end{matrix}$$

When F_{L}=F_{S}=0, standard covered buy-write (CBW) and collateralized put-write (CPW) have about the same Delta. Calibrated with SPX and VIX data at monthly option expiration Fridays, the Delta is estimated at 0.580 for the period from Jan. 19, 1990 to Dec. 17, 2010. This monthly Delta estimation is slightly smaller than the daily return beta 0.600 of SPTR GCBC-ALOOP (F_{L}=0, F_{S}=0) for the similar but 1.5 year longer period from Jun. 1, 1988 to Dec. 31, 2010 in Table 10. The deviations are mostly due to the slight out-of-money-ness of SPX options used in BXM and PUT, and the fact that their option components are rebalanced monthly rather than daily. It is also interesting to notice that this Delta estimation of SPTR GCBC-ALOOP (F_{L}=0, F_{S}=0) is between PUT beta=0.571 and BXM beta=0.635 in Table 4, and closer to the lower PUT beta. This can be explained that SPTR GCBC-ALOOP (F_{L}=0, F_{S}=0) spent more months following Golden Cross signal to take PUT position rather than the months spent following Black Cross signal to take the BXM position.

Neglecting volatility skew effects relating to

$$\frac{\partial ln {σ}_{BS}}{\partial ln S} ,$$

the formulae Δ×(SPTR−B)+B (using Δ as β in CAPM form) can define an active benchmark portfolio:

$${\prod }_{SPTR}^{0} ( {F}_{L} , {F}_{S} ) = \{ \begin{matrix}( \frac{1}{2} + {F}_{L} ) \cdot SPTR + ( \frac{1}{2} - {F}_{L} ) \cdot B , & when 50 DMA \geq 200 DMA on SPTR \\ ( \frac{1}{2} - {F}_{S} ) \cdot SPTR + ( \frac{1}{2} - {F}_{S} ) \cdot B , & when 50 DMA < 200 DMA on SPTR\end{matrix}$$

which matches the Delta or beta exposure of SPTR GCBC-ALOOP with the same leverage factors F_{L} and F_{S}. Excess return of Π_{SPTR}⁰ (F_{L}, F_{F}) over that of SPTR represents an active alpha of the Golden Cross/Black Cross scheme of the active benchmark portfolio. It is obvious that Π_{SPTR}⁰ (0.5,0.5) is just SPTR GC-LEO. Another special case implies that when the effect of VIX skew is omitted, SPTR GCBC-ALOOP (F_{L}=0.8, F_{S}=0.2) has 130% market exposure following Golden Cross signal and 30% market exposure following Black Cross signal. Taking the difference between SPTR GCBC-ALOOP and the benchmark active portfolio Π_{SPTR}⁰ (F_{L},F_{S}) leads to a self-financed, nominally Delta neutral active portfolio V_{SPTR} that is independent of factors of leverage F_{L} and F_{S}:

$${V}_{SPTR} = \{ \begin{matrix}PUT - \frac{1}{2} \cdot ( SPTR + B ) , & when 50 DMA \geq 200 DMA on SPTR \\ BXM - \frac{1}{2} \cdot ( SPTR + B ) , & when 50 DMA < 200 DMA on SPTR\end{matrix}$$

The return of V_{SPTR} can define an “active volatility skew premium”, as it corresponds to the market exposure through the

$$\frac{\partial ln {σ}_{BS}}{\partial ln S}$$

component of Delta for SPTR-GCBC ALOOP. Using daily return data of BXM, PUT and SPTR Index, the monthly option expiration Friday's rebalance scheme, and the capital base of BXM or PUT, it is found the annualized return of V_{SPTR} for the period from Jun. 1, 1988 to Dec. 31, 2010 is 3.25%.

Return for a SPTR GCBC-ALOOP can be thus attributed to the return of its active benchmark portfolio, the active volatility skew premium, and their interaction. The component of interaction is calculated as any excess return of SPTR GCBC-ALOOP over the sum of return of the active benchmark portfolio and the active volatility skew premium. For the return of the active benchmark portfolio Π_{SPTR}⁰ (F_{L},F_{S}), it can be further attributed to an active alpha over SPTR. SPTR also has a commonly defined Equity Risk Premium over risk free rate. Table 13 listed the return attribution for the three special cases of SPTR GCBC-ALOOP mentioned earlier that satisfy F_{L}+F_{S}=1. The interaction turns out to be always positive for the whole period.

TABLE 13
Annualized Return Attribution of SPTR GCBC-ALOOP Cases
Over period from Jun. 1, 1988 to Dec. 31, 2010

| | SPTR | SPTR | SPTR |
|---|---|---|---|
| | GCBC- | GCBC- | GCBC- |
| | ALOOP | ALOOP | ALOOP |
| | (F_{L} = 0.8, | F_{L} = 0.5, | (F_{L} = 0, |
| | F_{S} = 0.2) | (F_{S} = 0.5) | F_{S} = 1) |
| Risk Free Rate | 4.15% | 4.15% | 4.15% |
| Equity Risk Premium | 5.37% | 5.37% | 0.00% |
| Active Benchmark Alpha | 3.12% | 1.49% | 3.64% |
| Volatility Skew Risk | 3.25% | 3.25% | 3.25% |
| Premium | | | |
| Interaction of Active Alpha/ | 0.59% | 0.62% | 0.45% |
| Volatility Skew Premium | | | |
| Total Return | 16.48% | 14.87% | 11.49% |

In Table 13 when computing active benchmark alpha (alpha of active benchmark portfolio), SPTR GCBC-ALOOP (F_{L}=0.8, F_{S}=0.2) and SPTR GCBC-ALOOP (F_{L}=0.5, F_{S}=0.5) use SPTR as the benchmark, while SPTR GCBC-ALOOP (F_{L}=0, F_{S}=1) uses 3-month T-Bills as the benchmark.

As volatility skew representation

$$\frac{\partial ln {σ}_{BS}}{\partial ln S}$$

is mostly negative, market exposure of both the active benchmark portfolio and the volatility skew component are expected to be positive in bullish period following a Golden Cross. Thus their interaction was a positive return because SPTR index gained historically more often in the months following Golden Cross. They out-numbered the months following Black Cross at 144 to 54 when SPX changed month-to-month at least 1%, as shown in Table 12. For the time periods following a Black Cross, volatility skew representation

$$\frac{\partial ln {σ}_{BS}}{\partial ln S}$$

was also more often negative (47 out of 54 months from Table 12) to lead to an increased SPTR market exposure as well.

When examining SPTR GCBC-ALOOP return attribution in each year (Table 14 a-c) for 1988-2010, it is found that “active benchmark return” dominates the level of overall alpha and interaction return contributions were smaller. Only four years had negative volatility skew premium (1995, 2001, 2008 and 2010). The worst annual “active benchmark alpha” happened in 1998 and 2010, that led to the largest annual under-performance of SPTR GCBC-ALOOP (F_{L}=0.8, F_{S}=0.2), over 10% below SPTR in both years as shown Table 14(b). For the preceding two years (1997 and 2009), SPTR GCBC-ALOOP (F_{L}=0.8, F_{S}=0.2) had the best total alphas of over 20% due to superior volatility skew premium and interaction returns during those two years, as shown in Table 14(b)

In Table 14 (a-c), 1988 is recorded for partial year from Jun. 1, 1988 to Dec. 31, 1988. In Table 14(a), “Total Alpha” is the difference of annual returns between SPTR GCBC-ALOOP (F_{L}=0.5, F_{S}=0.5) and SPTR. “Active Benchmark” refers to SPTR GC-LEO and “Active Benchmark Alpha” is the difference of annual returns between SPTR GCBC-LEO and SPTR.

For monthly performance between option expiration Fridays, volatility skew can interact with a Golden Cross or Black Cross signal to exacerbate underperformance of SPTR GCBC-ALOOP (F_{L}=0.5, F_{S}=0.5) relative to its active benchmark portfolio SPTR GC-LEO. For example, on Aug. 21, 1998, VIX closed at σ_{BS}=33.14%, and ex post estimate of volatility skew

$$\frac{\partial ln {σ}_{BS}}{\partial ln S} = - 7.66 .$$

This caused the effective Δ=1.29 for SPTR GCBC-ALOOP (F_{L}=0.5, F_{S}=0.5): an extra 29% market exposure when the following month was still in Golden Cross bullish period but SPTR declined. On Sep. 19, 2008, monthly ex post estimate

$$\frac{\partial ln {σ}_{BS}}{\partial ln S} = - 14.61$$

with VIX at σ_{BS}=32.07% to cause the effective Δ˜0.54. Thus the volatility skew effect led to an extra 54% portfolio market exposure even when the period was bearish under a correct Black Cross signal.

TABLE 14 (a)
SPTR GCBC-ALOOP (F_{L} = 0.5, F_{S} = 0.5) Return Attribution
Year by Year (1988-2010)

| | | Active Benchmark | Volatility Skew | |
|---|---|---|---|---|
| Year | Total Alpha | Alpha | Risk Premium | Interaction |
| 1988* | 2.08% | −1.05% | 1.80% | 1.33% |
| 1989 | 5.32% | 0.00% | 4.51% | 0.80% |
| 1990 | −1.31% | −6.31% | 5.47% | −0.48% |
| 1991 | −6.91% | −10.20% | 2.22% | 1.07% |
| 1992 | 8.31% | 0.00% | 6.94% | 1.38% |
| 1993 | 7.82% | 0.00% | 7.11% | 0.71% |
| 1994 | −0.03% | −4.37% | 4.51% | −0.16% |
| 1995 | −4.39% | 0.00% | −3.00% | −1.39% |
| 1996 | 2.72% | 0.00% | 0.92% | 1.81% |
| 1997 | 10.17% | 0.00% | 7.93% | 2.25% |
| 1998 | −17.00% | −20.26% | 2.75% | 0.51% |
| 1999 | 8.72% | 0.00% | 7.57% | 1.15% |
| 2000 | 20.27% | 8.07% | 11.21% | 0.99% |
| 2001 | 8.39% | 15.50% | −6.45% | −0.65% |
| 2002 | 25.05% | 20.77% | 4.93% | −0.65% |
| 2003 | −1.44% | −9.16% | 6.17% | 1.55% |
| 2004 | 1.75% | −1.96% | 3.07% | 0.64% |
| 2005 | 2.49% | 0.00% | 2.20% | 0.29% |
| 2006 | 1.84% | −2.89% | 4.14% | 0.59% |
| 2007 | 5.06% | 0.76% | 3.66% | 0.64% |
| 2008 | 27.83% | 38.43% | −10.31% | −0.29% |
| 2009 | 11.27% | −3.57% | 10.34% | 4.50% |
| 2010 | −16.69% | −15.19% | −1.01% | −0.48% |

There are eight scenarios with the combinations of a “right” or “wrong” Golden Cross or Black Cross signal, and a negative or positive volatility skew

$$\frac{\partial ln {σ}_{BS}}{\partial ln S} .$$

Two of them stand out from a risk management perspective for a SPTR GCBC-ALOOP portfolio.

First situation is a negative volatility skew

$$\frac{\partial ln {σ}_{BS}}{\partial ln S}$$

under a wrong Golden Cross signal. This could be when market declines quickly after a bull-run with the market fear gage VIX spikes to the upside.

Another situation is positive volatility skew

$$\frac{\partial ln {σ}_{BS}}{\partial ln S}$$

under a wrong Black Cross signal. This could be that the market rise from lows but VIX still increases, as market participants disbelieve the bounce and buy further into SPX options for protection.

To address the issue of SPTR GCBC-ALOOP portfolio risk management, two trading rules within an SPX option month are proposed as an example for back testing. Aiming to correct the wrong market exposure, they are named as Delta trades. As an out-of-sample back test, Delta trades criteria use an ex ante estimation of volatility skew: the change of VIX relative to the change in SPX index since the beginning of the option month, as a predictor of its impact on portfolio market exposure for the remainder of the option month.

TABLE 14 (b)
SPTR GCBC-ALOOP (F_{L} = 0.8, F_{S} = 0.2) Return Attribution
Year by Year (1988-2010)

| | | Active Benchmark | Volatility Skew | |
|---|---|---|---|---|
| Year | Total Alpha | Alpha | Risk Premium | Interaction |
| 1988* | 2.41% | −0.68% | 1.80% | 1.28% |
| 1989 | 13.20% | 7.26% | 4.51% | 1.42% |
| 1990 | −4.70% | −9.40% | 5.47% | −0.78% |
| 1991 | 1.11% | −2.75% | 2.22% | 1.64% |
| 1992 | 9.53% | 1.02% | 6.94% | 1.57% |
| 1993 | 10.10% | 2.00% | 7.11% | 0.99% |
| 1994 | −1.05% | −5.39% | 4.51% | −0.18% |
| 1995 | 6.35% | 11.06% | −3.00% | −1.70% |
| 1996 | 8.46% | 5.46% | 0.92% | 2.08% |
| 1997 | 20.27% | 8.82% | 7.93% | 3.52% |
| 1998 | −10.51% | −14.19% | 2.75% | 0.93% |
| 1999 | 13.62% | 4.39% | 7.57% | 1.65% |
| 2000 | 14.94% | 2.88% | 11.21% | 0.85% |
| 2001 | 4.09% | 11.06% | −6.45% | −0.51% |
| 2002 | 17.31% | 13.72% | 4.93% | −1.35% |
| 2003 | 8.09% | −0.22% | 6.17% | 2.14% |
| 2004 | 4.64% | 0.78% | 3.07% | 0.78% |
| 2005 | 2.76% | 0.27% | 2.20% | 0.29% |
| 2006 | 5.25% | 0.26% | 4.14% | 0.85% |
| 2007 | 5.00% | 0.48% | 3.66% | 0.85% |
| 2008 | 15.94% | 26.50% | −10.31% | −0.26% |
| 2009 | 21.40% | 5.71% | 10.34% | 5.35% |
| 2010 | −12.88% | −11.33% | −1.01% | −0.54% |

In the bullish period following a SPTR Golden Cross, on the first Friday after last option expiration, check the following two criteria at close to 4:00 PM:

$$ln ( {SPX}_{t + n} / {SPX}_{t} ) < - 1 \% , and {VIX}_{t + n} \times ( \frac{ln {VIX}_{t + n} - ln {VIX}_{t}}{ln {SPX}_{t + n} - ln {SPX}_{t}} ) < - 2$$

Where t denotes the close prices of last option expiration Friday and n=1 week. Only when both are satisfied, trade to the bearish branch position for the SPTR GCBC-ALOOP portfolio on the same day, and keep the portfolio position until next monthly option expiration.

In the bearish period following a SPTR Black Cross, on the first and second Friday after last option expiration, check the following two criteria at close to 4:00 PM:

$$ln ( {SPX}_{t + n} / {SPX}_{t} ) > \frac{1}{4} \% , and {VIX}_{t + n} ( \frac{ln {VIX}_{t + n} - ln {VIX}_{t}}{ln {SPX}_{t + n} - ln {SPX}_{t}} ) > 1$$

Where t denotes the close prices of last option expiration Friday and n=1 week or 2 weeks. Only when both are satisfied, trade to the bullish branch position for the SPTR GCBC-ALOOP portfolio on the same day, and keep the portfolio position until next monthly option expiration.

TABLE 14 (c)
SPTR GCBC-ALOOP (F_{L} = 0, F_{S} = 1) Return Attribution
Year by Year (1988-2010)

| | | Active Benchmark | Volatility Skew | |
|---|---|---|---|---|
| Year | Total Alpha | Alpha | Risk Premium | Interaction |
| 1988* | 3.03% | −0.06% | 1.80% | 1.28% |
| 1989 | 15.72% | 11.13% | 4.51% | 0.08% |
| 1990 | −7.27% | −12.72% | 5.47% | −0.02% |
| 1991 | 5.53% | 2.58% | 2.22% | 0.73% |
| 1992 | 10.16% | 2.10% | 6.94% | 1.13% |
| 1993 | 10.98% | 3.50% | 7.11% | 0.36% |
| 1994 | −1.64% | −6.06% | 4.51% | −0.09% |
| 1995 | 10.98% | 14.90% | −3.00% | −0.92% |
| 1996 | 11.00% | 8.64% | 0.92% | 1.44% |
| 1997 | 22.26% | 13.64% | 7.93% | 0.69% |
| 1998 | −4.15% | −7.01% | 2.75% | 0.11% |
| 1999 | 15.99% | 8.08% | 7.57% | 0.34% |
| 2000 | 13.83% | 0.95% | 11.21% | 1.67% |
| 2001 | −0.65% | 6.83% | −6.45% | −1.03% |
| 2002 | 13.36% | 8.46% | 4.93% | −0.03% |
| 2003 | 11.02% | 4.32% | 6.17% | 0.53% |
| 2004 | 6.27% | 2.79% | 3.07% | 0.41% |
| 2005 | 3.40% | 0.93% | 2.20% | 0.27% |
| 2006 | 7.01% | 2.60% | 4.14% | 0.27% |
| 2007 | 5.64% | 1.50% | 3.66% | 0.48% |
| 2008 | 8.19% | 19.38% | −10.31% | −0.88% |
| 2009 | 20.05% | 7.07% | 10.34% | 2.64% |
| 2010 | −8.37% | −7.01% | −1.01% | −0.34% |

Both types of Delta trades check weekly the adverse portfolio market exposure early in an option month. The criteria are derived from threshold values based on observation of statistical outliers of historical volatility skew. The Delta trades switch the direction of portfolio leverage assuming the unfavorable market rising or declining trend since last option expiration continues until the next option expiration.

Table 14(a-c) lists all the ten Delta trades in the whole back test period and their performance for three special cases of SPTR GCBC-ALOOP with F_{L}+F_{S}=1. Pre-2010 Delta trades all resulted in net gains. The two Delta trades in 2010 can result in net gains if the criteria are checked daily during the first week of the option month rather than waiting until first Friday. As a result, the January 2010 Delta trade was pulled one day ahead to Jan. 21, 2010, and the May 2010 Delta trade was pulled two days ahead to May 19, 2010.

As shown in Table 14, all five Delta trades during bearish periods following a Black Cross result in net gains compared to the original active portfolio without Delta trades. Three pre-2010 Delta trades during bullish periods following a Golden Cross result in relative larger net gains—all over +4%. Two Delta trades in 2010 are both bullish period risk management type that ended in modest monthly net loss. However daily monitoring to trigger the couple of Delta trades one or two days earlier can lead to net monthly gains. Since leverage parameters have F_{L}+F_{S}=1 for the SPTR GCBC-ALOOP cases, the Delta trades only involve closing written call options in BXM and then short put options in PUT (call-write to put-write type) in the bearish Black Cross period, or closing written put options and then short call options (put-write to call-write type) in the bullish Golden Cross period. The amount of rebalance between underlying SPX index position and the T-bills is negligible for Delta trades. Thus the net gains in the last columns of Table 14(a-c) are essentially the same for the same date of Delta trades regardless different leverage factors for the three Table's SPTR GCBC-ALOOP cases.

TABLE 15 (a)
Performance of SPTR GCBC-ALOOP (F_{L} = 0.8, F_{S} = 0.2) Delta Trades During Jan. 19, 1990 to Dec. 31, 2010

| | | | | Monthly Return of | Monthly Return of | |
|---|---|---|---|---|---|---|
| Option Month | SPTR | Delta Trade | Direction of | SPTR GCBC-ALOOP | SPTR GCBC-ALOOP | Delta Trade |
| (ending) | Monthly Return | Date | Delta Trade | with Delta Trade | without Delta Trade | Net Monthly P/L |
| Aug. 17, 1990 | −8.99% | Jul. 27, 1990 | Put-Write to | −7.79% | −14.61% | 6.81% |
| | | | Call-Write | | | |
| Dec. 21, 1990 | 4.90% | Nov. 30, 1990 | Call-Write to | 4.24% | 2.05% | 2.19% |
| | | | Put-Write | | | |
| Aug. 21, 1998 | −8.75% | Jul. 24, 1998 | Put-Write to | −9.30% | −13.45% | 4.14% |
| | | | Call-Write | | | |
| Oct. 20, 2000 | −4.62% | Sep. 22, 2000 | Put-Write to | −2.87% | −7.32% | 4.45% |
| | | | Call-Write | | | |
| May 18, 2001 | 4.08% | Apr. 27, 2001 | Call-Write to | 4.74% | 2.37% | 2.38% |
| | | | Put-Write | | | |
| Aug. 16, 2002 | 9.73% | Aug. 2, 2002 | Call-Write to | 10.11% | 4.28% | 5.83% |
| | | | Put-Write | | | |
| Feb. 15, 2008 | 2.05% | Jan. 25, 2008 | Call-Write to | 5.09% | 3.28% | 1.81% |
| | | | Put-Write | | | |
| May, 15, 2009 | 1.75% | May 1, 2009 | Call-Write to | 3.14% | 2.24% | 0.90% |
| | | | Put-Write | | | |
| Feb. 19, 2010 | −2.15% | Jan. 21, 2010* | Put-Write to | −1.69% | −2.69% | 0.99% |
| | | Jan. 22, 2010 | Call-Write | −3.90% | | −1.21% |
| Jun. 18, 2010 | −1.36% | May 19, 2010* | Put-Write to | −2.65% | −4.96% | 2.31% |
| | | May 21, 2010 | Call-Write | −8.33% | | −3.37% |

For over two decades, the monthly average realized volatilities for S&P 500 index has been below the average implied volatilities for SPX index options. This is often quoted as the direct reason to pursue out-performance through index option writing strategies. Other methods to trade directly on the SPX implied-realized volatility spreads include, for example, OTC Variance Swaps for S&P 500 Index and CBOE VIX futures contracts.

However, passive buy-write or put-write portfolio strategies may not be fully efficient to take advantage of the average negative volatility premium embedded in index options. Exercise cost (payment to settle in-the-money written options at expiration) turned out to be the largest performance drag on passive buy-write strategies. In a rising market, buy-write strategy under-performs the underlying equity index due to non-zero exercise cost even when the market gains less than what was initially implied by the at-the-money index option premium. When market declines, a buy-write strategy like BXM avoids exercise cost but the portfolio still ends with a loss, since the call premium collected is not enough to offset the loss from fully invested underlying index position (as call option |Delta|<1). A collateralized put-write strategy like PUT index will incur exercise cost when market declines. The portfolio can also suffer disastrous losses under market stress, e.g. PUT index has a daily paper loss of 24.4% on Oct. 19, 1987, worse than S&P 500 index! Even when markets rise, large cash positions required by put-write strategy make funding expense and opportunity cost concerns for investors, and prevent its implementation in form of a structured product investment.

TABLE 14 (b)
Performance of SPTR GCBC-ALOOP (F_{L} = 0.5, F_{S} = 0.5) Delta Trades During Jan. 19, 1990 to Dec. 31, 2010

| | | | | Monthly Return of | Monthly Return of | |
|---|---|---|---|---|---|---|
| Option Month | SPTR | Delta Trade | Direction of | SPTR GCBC-ALOOP | SPTR GCBC-ALOOP | Delta Trade |
| (ending) | Monthly Return | Date | Delta Trade | with Delta Trade | without Delta Trade | Net Monthly P/L |
| Aug. 17, 1990 | −8.99% | Jul. 27, 1990 | Put-Write to | −5.00% | −11.78% | 6.78% |
| | | | Call-Write | | | |
| Dec. 21, 1990 | 4.90% | Nov. 30, 1990 | Call-Write to | 2.91% | 0.72% | 2.18% |
| | | | Put-Write | | | |
| Aug. 21, 1998 | −8.75% | Jul. 24, 1998 | Put-Write to | −6.63% | −10.72% | 4.09% |
| | | | Call-Write | | | |
| Oct. 20, 2000 | −4.62% | Sep. 22, 2000 | Put-Write to | −1.36% | −5.80% | 4.44% |
| | | | Call-Write | | | |
| May 18, 2001 | 4.08% | Apr. 27, 2001 | Call-Write to | 3.58% | 1.20% | 2.37% |
| | | | Put-Write | | | |
| Aug. 16, 2002 | 9.73% | Aug. 2, 2002 | Call-Write to | 7.20% | 1.39% | 5.81% |
| | | | Put-Write | | | |
| Feb. 15, 2008 | 2.05% | Jan. 25, 2008 | Call-Write to | 4.51% | 2.71% | 1.80% |
| | | | Put-Write | | | |
| May 15, 2009 | 1.75% | May 1, 2009 | Call-Write to | 2.62% | 1.72% | 0.89% |
| | | | Put-Write | | | |
| Feb. 19, 2010 | −2.15% | Jan. 21, 2010* | Put-Write to | −1.04% | −2.04% | 1.00% |
| | | Jan. 22, 2010 | Call-Write | −3.22% | | −1.18% |
| Jun. 18, 2010 | −1.36% | May 19, 2010* | Put-Write to | −2.23% | −4.55% | 2.32% |
| | | May 21, 2010 | Call-Write | −7.84% | | −3.29% |

The long term persistence of rich index option premium since 1987 market crash led to more fundamental, market structural, and behavioral finance based explanations. Given the historical regulatory and technology limitations, lack of common, liquid and efficient investment vehicles to arbitrage away the negative “realized—implied volatility spread” could be added to the long list of interpretations. The current approach of ALOOP (Active Leveraged Option Overly Portfolio) addresses the directional deficiencies of standard buy-write and put-write strategies by trying to avoid all exercise costs. It relies on reasonable predictability of mid-to-long term trends of stock market index time series. For example, historical Golden Cross/Black Cross signals are found effective from an empirical analysis of historical data; further, the introduction of directional leverage for the portfolio agrees with the theoretical framework of the dynamic asset allocation that switches fixed portfolio weights according to a moving average technical analysis rule.

TABLE 14 (c)
Performance of SPTR GCBC-ALOOP (F_{L} = 0, F_{S} = 1) Delta Trades During Jan. 19, 1990 to Dec. 31, 2010

| | | | | Monthly Return of | Monthly Return of | |
|---|---|---|---|---|---|---|
| Option Month | SPTR | Delta Trade | Direction of | SPTR GCBC-ALOOP | SPTR GCBC-ALOOP | Delta Trade |
| (ending) | Monthly Return | Date | Delta Trade | with Delta Trade | without Delta Trade | Net Monthly P/L |
| Aug. 17, 1990 | −8.99% | Jul. 27, 1990 | Put-Write to | −0.29% | −7.07% | 6.79% |
| | | | Call-Write | | | |
| Dec. 21, 1990 | 4.90% | Nov. 30, 1990 | Call-Write to | 0.71% | −1.49% | 2.20% |
| | | | Put-Write | | | |
| Aug. 21, 1998 | −8.75% | Jul. 24, 1998 | Put-Write to | −2.09% | −6.16% | 4.07% |
| | | | Call-Write | | | |
| Oct. 20, 2000 | −4.62% | Sep. 22, 2000 | Put-Write to | 1.18% | −3.28% | 4.45% |
| | | | Call-Write | | | |
| May 18, 2001 | 4.08% | Apr. 27, 2001 | Call-Write to | 1.64% | −0.73% | 2.37% |
| | | | Put-Write | | | |
| Aug. 16, 2002 | 9.73% | Aug. 2, 2002 | Call-Write to | 2.40% | −3.43% | 5.82% |
| | | | Put-Write | | | |
| Feb. 15, 2008 | 2.05% | Jan. 25, 2008 | Call-Write to | 3.54% | 1.74% | 1.80% |
| | | | Put-Write | | | |
| May 15, 2009 | 1.75% | May 1, 2009 | Call-Write to | 1.74% | 0.86% | 0.89% |
| | | | Put-Write | | | |
| Feb. 19, 2010 | −2.15% | Jan. 21, 2010* | Put-Write to | 0.04% | −0.96% | 1.00% |
| | | Jan. 22, 2010 | Call-Write | −2.13% | | −1.16% |
| Jun. 18, 2010 | −1.36% | May 19, 2010* | Put-Write to | −1.54% | −3.87% | 2.32% |
| | | May 21, 2010 | Call-Write | −7.07% | | −3.20% |

From the portfolio Delta dissemination, a negative volatility skew can be understood as an ex ante representation of alpha source of the negative “realized—implied volatility spread”. Overall positive return from the interaction between volatility skew risk premium and active benchmark alpha is found from the 22.6 years of back test, indicating the portfolio mechanism of combining active leverage and option overlay can create synergy over long term. By adjusting the level of active leverage, specific portfolio can be designed to suit to aggressive, moderate or conservative investors. Short term index option trades are back tested against problematic signals from technical analysis rules, and they turned out effective for portfolio risk management under adverse market volatility environment.

Although S&P 500 Index is chosen as the underlying index in this practical model illustration and back-test with historical data, the current invention can be applied to other broad market indexes such as Dow Jones Industrial Average, NASDAQ 100 and Russell 2000, and compare to their respective existing option strategy benchmark index (Buy-Write) which are already available from CBOE.

Special cases of the ALOOP portfolios, e.g., SPTR-GCBC ALOOP (F_{L}=0.8, F_{S}=0.2), can be implemented as an alternative to common equity index investments.

Given the potential market size, market impact of extra option transactions from ALOOP can be important. Hypothetically, on dates when option contracts are rolled over or a technical signal is triggered, additional selling supply of index options can press the bid prices lower. The directional leverage implied in the option positions can cause additional momentum for the underlying index at these key dates. However, diversification of rebalance schedules and technical rules are possible among market participants that could mitigate potential trading event risk.

One can use Thursdays before monthly option expiration (two days ahead of expiration rather than one) to rebalance ALOOP and roll over written put or call options.

One can use a single moving average cross of 200 day moving average as the first technical rule, and additionally use a 5 day or more holding period after 200 DMA cross before actually switching between put or call writing positions and portfolio rebalancing. The optional holding period method can reduce the frequency of technical rule triggered trades and help controlling transaction costs.

At other times beyond the portfolio rebalance or technical rule triggered change, the convex nature of index option writing can dampen market move and possibly reduce underlying index volatility gradually. The mechanism can be that option market maker or other counter parties Delta hedge their positions in the underlying or index futures markets. Lower realized index volatility reduces average exercise cost and compensates potential lower option premium collected by index writing portfolio. In that sense, aligned with a liquid and efficient underlying equity index market, the current method of an active index writing portfolio might expect its efficacy, as observed in the 22.6 years of back test, to last in further practical test and implementation for decades to come.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that while the examples described herein illustrate how the features may be used in an electronic trading environment, other types of trading environment, computing environments, and software development systems may use and benefit from the invention. The investment portfolio examples given are presented for purposes of illustration. It will be evident that the techniques described herein may be applied in other types of investment instruments, with different types of assets.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for supporting an electronic pricing and trading platform, the method comprising the steps of:
allowing an investment portfolio in the electronic pricing and trading platform to have a portion of long exposure to one or more underlying equities, or equity index investments;
using a technical rule to determine a pricing trend associated with the one or more underlying equities, or equity index investments periodically, wherein the technical rule is electronically calculated based on prices of the one or more underlying equities, or equity index investments, and the determined pricing trend is one of an up trend and a down trend; and
associating an option overlay component with the investment portfolio, wherein
if the determined pricing trend is an up trend, the option overlay component is a first option overlay component that contains one or more written or shorting put options associated with the one or more underlying equities, or equity index investments, and
if the determined pricing trend is a down trend, the option overlay component is a second option overlay component that contains one or more written or shorting call options associated with the one or more underlying equities, or equity index investments.

2. The method according to claim 1, further comprising:
when the determined pricing trend changes from an up trend to a down trend, performing adjusting the portion of long exposure to one or more underlying equities or equity index investments,
disassociating the first option overlay component with the investment portfolio, and
associating the second option overlay component with the investment portfolio.

3. The method according to claim 1, further comprising:
when the determined pricing trend changes from a down trend to an up trend, performing adjusting the portion of long exposure to one or more underlying equities, or equity index investments,
disassociating the second option overlay component with the investment portfolio, and
associating the first option overlay component with the investment portfolio.

4. The method according to claim 1, further comprising:
the technical rule is based on a market timing scheme that uses single or double moving average across signals, including but not restricted to, daily, weekly, monthly or quarterly signals from Golden Cross and Black Cross, or from a 200 day (or 40-week) single moving average cross with or without a weekly or longer holding period, counting from the day of the moving average cross.

5. The method according to claim 1, further comprising:
the technical rule is based on a model-based investment portfolio Delta estimation that relates the investment portfolio's market exposure to index price level, index option implied volatility, index option volatility skew, and index price moving average.

6. The method according to claim 1, further comprising:
allowing the one or more underlying equities to be a basket of stocks representing an equity market index.

7. The method according to claim 1, further comprising:
allowing the equity index investment to be an Exchange Traded Fund (ETF), Exchange Traded Note (ETN), or an open-ended or closed ended mutual fund representing an equity market index; or futures or swaps contracts, equity linked investment or structured investment products that uses an equity market index as the underlying asset.

8. The method according to claim 1, further comprising:
allowing the investment portfolio to have long exposure to risk free assets, which can be cash or cash equivalent instruments, short term government debt, money market funds, discounted notes from government agencies, or certificates of deposits, or any short term rate forward agreements or swap contracts with a bank or a financial institution that satisfies the requirement of Clearing House for an Option Exchange as performance bond collaterals, or their combinations of such.

9. The method according to claim 1, further comprising:
allowing the investment portfolio to have option overlays that can be written put or call options on one or more equities, or options on an equity index, options on an Exchange Traded Funds (ETF) representing the underlying equity index, options on futures representing the underlying equity index, or any over-the-counter European or American style options based on the underlying equity index.

10. The method according to claim 1, further comprising:
allowing the investment portfolio to roll over the written put or call options to further future expirations, and rebalance portfolio to target allocations for exposure in both equity index and risk free bonds.

11. The method according to claim 1, further comprising:
when the determined pricing trend is an up trend, defining a factor of leverage for the investment portfolio based on a portion of exposure of the investment portfolio to the underlying equities or equity index investments and an associated portion of allocation of the investment portfolio to risk free assets.

12. The method according to claim 1, further comprising:
when the determined pricing trend is a down trend, defining a factor of leverage for the investment portfolio based on a portion of exposure of the investment portfolio to the underlying equities or equity index investments and an associated portion of allocation of the investment portfolio to risk free assets.

13. A system for supporting an electronic pricing and trading platform, comprising:
a computer platform with data server module, core analytics module, and a trading transaction module, that each has one or more processors, memory, and network interface, that transmits prices and index data or order information between platforms of financial exchanges and other intermediaries, wherein the computer platform operates to perform the steps of:
allowing an investment portfolio to have long exposure to one or more underlying equities or equity index;
using a technical rule to determine a pricing trend associated with the one or more underlying equities periodically, wherein the technical rule is electronically calculated based on prices of the one or more underlying equities or equity index, and the determined pricing trend is one of an up trend and a down trend; and
associating an option overlay component with the investment portfolio, wherein
if the determined pricing trend is an up trend, the option overlay component contains a first option overlay component that contains one or more written or shorting put options associated with the one or more underlying equities or equity index, and
if the determined pricing trend is a down trend, the option overlay component contains a second option overlay component that contains one or more written or shorting call options associated with the one or more underlying equities or equity index.

14. A method for supporting an electronic pricing and trading platform that provides investment benchmark index, the method comprising the steps of:
allowing the investment benchmark index referencing the total value of an actual or hypothetical investment portfolio that has a portion of long exposure to one or more underlying equities or equity indices;
using a technical rule to determine a pricing trend associated with the one or more underlying equities or equity index periodically, wherein the technical rule is electronically calculated based on prices of the one or more underlying equities or equity indices, and the determined pricing trend is one of an up trend and a down trend; and
associating an option overlay component with the referenced portfolio, wherein
if the determined pricing trend is an up trend, the option overlay component is a first option overlay component that contains one or more written or shorting put options associated with the one or more underlying equities, or equity index investments, and
if the determined pricing trend is a down trend, the option overlay component is a second option overlay component that contains one or more written or shorting call options associated with the one or more underlying equities, or equity index investments.
